(19) United States
(12) Patent Application Publication
(10) Pub. No.: US 2010/0176044 A1
(43) Pub. Date: Jul. 15, 2010

(54) FILTER MEDIUM

(75) Inventors: Abraham J. Domb, Efrat (IL); Haim Wilder, Raanana (IL); Rami Ronen, Ramat HaSharon (IL); Stanislaw Ratner, Jerusalem (IL)

Correspondence Address: THE NATH LAW GROUP, 112 South West Street, Alexandria, VA, 22314, US

(73) Assignee: H2Q WATER INDUSTRIES LTD., Ramat Gan (IL)

(21) Appl. No.: 12/450,837

(22) PCT Filed: Apr. 27, 2008
(86) PCT No.: PCT/IL2008/000553

§ 371 Date: Mar. 22, 2010

Related U.S. Application Data
(60) Provisional application No. 60/907,817, filed on Apr. 18, 2007.

(51) Int. Cl. C02F 1/42; B01D 15/04; B01J 20/22; B01J 20/20; B01J 20/02; B01J 20/10; B01J 20/08

(52) U.S. Cl. 210/205; 210/287; 210/264; 502/404; 502/416; 502/406; 502/413; 502/415; 977/773

(57) ABSTRACT

The present subject matter provides a filter medium for filtering aqueous solutions, particularly water for human and animal consumption. The medium may be employed in a great variety of filters of various sizes and constructions.

### FIELD OF THE INVENTION

This invention generally relates to a filter medium for treating a liquid, preferably for providing potable water.

### BACKGROUND OF THE INVENTION

The importance of good drinking water in maintaining human health is well recognized and has been the reasoning behind the development of a great variety of water-treatment technologies. Amongst the well-established technologies, filtration is recognized as an effective means of removing not only solid particulates of various sizes but also dissolved matter and biological agents routinely present in the water. The choice of which filtration methodology to use from the great variety of available technologies depends on the characteristics of the water, the degree of water contamination, and the costs involved in the manufacture, assembly and operation of such technologies.

One of the primary reasons why filtration has become the forerunning method of water treatment in recent years is its use of both chemical and physical processes to block contaminant passage. Solid block carbon and multimedia filters are not merely the only water treatment products that can remove contaminants in drinking water; they are also capable of retaining healthy, pH-balancing minerals in the water. The adsorptive process of such filters attracts the contaminants to the filter medium while allowing mineral sediments to pass through the filter.

The filtration process employed both in household applications as well as industrial or municipal applications, generally utilizes a filter medium through which water passes. Such filter medium range from sand, for older filters, and solid block carbon or carbon medium mixtures for newer filters. The filtration process generally involves several stages, through which contaminants are removed or reduced in order of importance. In the first stage of a traditional filtration process, the concentration of the major chemical components, such as chlorine and volatile organic compounds, is significantly reduced. This preliminary reduction in concentration allows the remaining stages of filtration to focus on contaminants like pesticides and tiny microbes that are more difficult to filter. The subsequent stages of filtration focus on the reduction of metals, in ionized form or other soluble form, such as lead and chemicals from pesticide runoff. Thus, as the water passes through the stages of filtration, contaminants are both physically and chemically blocked from passage through the filter medium and exiting the filtering system.

### SUMMARY OF THE INVENTION

It has been the long sought objective of the inventors of the present invention to develop an inexpensive and safe-to-use generic filter material for use in liquid filters or filtration systems, preferably for water, that, on one hand, does not unduly restrict water flow therethrough, and on the other hand can filter particulate matter, harmful organic and inorganic substances and microorganisms, and prevent bacterial and viral growth within the filter medium, without releasing life harming toxins that necessitate further filtration.

The filter material, or as referred to herein “filter medium” of the invention is one such medium suitable for use in, for example, water treatment processes, namely in any one of numerous processes of making water suitable for its application or return to its natural state, and particularly for providing potable water.

The filter medium of the invention comprises solid, water-insoluble components, which may be used as a mixture of components or separately, i.e., in distinct chambers or layers of a filtering system. The three components are particulate carbonaceous material, particulate chitosan and/or an ion exchanger and a particulate metal oxide. This optimal combination of the components possesses a high separation capacity. It is efficient in removing out from the filtered liquid soluble (solute) or insoluble particulate materials such as heavy metals, chlorine residue, odor agents, color agents, trihalomethanes, and a variety of agricultural related agents such as pesticides.

The filter medium of the invention may further contain an antimicrobial component, which is capable of substantially preventing the accumulation therein of microorganisms such as bacteria. The filter medium of the invention may further contain an antimicrobial component which is capable of substantially killing or removing from the filtered water microorganisms such as bacteria, thus preventing the contamination of the filtered liquid.

The filter medium is thus suitable for the purification of drinking water, and various water sources.

Additionally, it has been determined that the filter medium combination of the invention provides a large enough filtering surface that effectively filters a large volume of water over a period of time without becoming clogged and without arresting or limiting the water flow therethrough. With the simplicity and generic nature of the filter medium, its incorporation in a great variety of filters and filtering systems possible. The filter medium may or may not be associated with a further medium or media for e.g., enhancing the filtration efficacy with respect of specific contaminants.

It should be noted that while the components of the filter medium have each been previously realized in filtering of liquids, the combination of the invention provides a medium which is effective both in terms of its ability to remove solute and insoluble matter from the liquid, as discussed, and also in terms of the time period it takes to achieve optimal efficacy. This duel effectiveness is clearly component-dependent and while a certain combination of other known components may be effective in, e.g., removing solute material, it may not have enough filtering surface, thus clogging or arresting the water flow therethrough. Similarly, while a certain combination may be effective against microorganisms, it may do so only after prolonged contact thereof with the medium.

In a first aspect of the present invention, there is provided a filter medium comprising a carbonaceous material, a metal oxide or hydroxide, and at least one of chitosan and an ion exchanger (namely chitosan and/or ion exchanger).

In one embodiment, the filter medium is suitable for use in the filtration of a liquid, said liquid being preferably water or containing water, e.g., a water solution.

The carbonaceous material employed in the filter medium of the invention is a carbon-based material which is capable of absorbing or adsorbing organic or inorganic matter to its surface. Typically, such carbonaceous material is a particulate material selected so as to be capable of absorbing or adsorbing the matter non-specifically and preferably also selected to have antimicrobial activity. The carbonaceous material may be selected, in a non-limiting fashion, from charcoal, activated charcoal, activated carbon, bituminous coal, impregnated activated carbon, bone char, acid washed activated carbon, coconut shell based activated carbon, wood based activated carbon, regenerated activated carbon, anthracite coal, zeolite mixed coal, virgin activated carbon, water-washed catalytic carbon, charred vegetation, fly ash, and others as may be known to a person skilled in the art.

In one embodiment, the carbonaceous material composes between about 30 to 75% of the total weight of the filter medium, more preferably between 40 and 70% and most preferably between 50 and 65% of the total weight of the medium.

In order to enhance the performance or efficacy of the carbonaceous material in removing solutes from the filtered liquid, and in some instances in order to impart to it antimicrobial activity, the carbonaceous material may be impregnated with a great variety of organic or inorganic compounds, such as cationic polymers, e.g. polyamines, anionic polymers, e.g. polysulfates, polysulfonates and carboxylic acid based polymers, salts, ions, metal ions or atoms, e.g., silver, zinc, copper, triethylenediamine, sulfur, titanium, and caustic.

The impregnation of the carbonaceous material does not typically exceed 5% of the total weight of the carbonaceous material. The impregnation may be either by physical adsorption or adsorption followed by crosslinking onto the carbon particles or bonding to the carbon particles.

In one embodiment, the carbonaceous material is impregnated with silver.

In another embodiment, the carbonaceous material is impregnated with copper.

In another embodiment, the carbonaceous material is activated carbon.

In yet another embodiment, the activated carbon is coconut shell based activated carbon.

In still another embodiment of the invention, the carbonaceous material, being preferably activated carbon, is associated with a medium comprising, for example, micronized metal salts or metal oxides such as iron oxide and titanium oxide.

The carbonaceous material may be present in the filter medium in any particulate form known in the industry, such as palletized, granular, fibrous, or crushed. In one embodiment, the carbonaceous material employed in the filter medium is substantially homogenous in form (for example all material is granular). In another embodiment, the carbonaceous material is a mixture of two or more particulate forms.

The metal oxide or hydroxide employed is also used as an adsorbent of various contaminants, such as metal and inorganic salts such as arsenic (both trivalent and pentavalent), lead and copper, halides, particularly iodine, and microorganisms. Similarly to the carbonaceous material employed, the metal oxide or hydroxide particulates have large surface area which allows for efficient adsorption, thus complimenting the already efficient adsorption of the carbonaceous matter.

The metal oxide particulates may be whole metal particulates or granules coated with the metal oxide or hydroxide. The metal oxide or hydroxide particulates may be a metal oxide, hydroxide or oxide-hydroxide combination. Such metal oxides may be selected from oxide, hydroxides and/or oxide-hydroxide of iron, alumina, titanium and silica, such as iron oxide particulates, aluminum oxide particulates, iron nanoparticles on aluminum oxide, iron nanoparticles on diatomaceous earth, iron nanoparticles on microlite ceramic spheres, iron oxide (Fe₂O₃) on silica (SiO₂), iron oxide on alumina (Al₂O₃), ceramic spheres coated with alumina, iron oxide on alumina, titanium oxide partially hydroxide, aluminum hydroxide (Al(OH)₃) on iron hydroxide (Fe(OH)₃) and iron hydroxide on aluminum hydroxide.

Preferably, the metal oxide is hydrated iron-oxide prepared from FeCl₃. The hydration process may be carried out in situ or prior to embedding onto the polymer. The hydrated iron oxide is embedded onto porous polystyrene beads which provide a high surface area and high diffusion rate through the beads while retaining the hydrated iron-oxide and preventing it from being carried out by the filtered water.

In some embodiments, the hydrated iron oxide is embedded in various other materials such as ceramic or polymeric supports.

In one particular embodiment, the hydrated iron oxide or hydroxide is embedded in a ceramic porous disc having a pore size of 100 to 500 microns. The embodiment with the hydrated iron oxide may be achieved in situ by hydrolysis of the iron chloride within the ceramic pores. Such a ceramic disc may be placed in the bottom of the filter so that it serves for the extra removal of trivalent and pentavalent metal ions including arsenic in addition to the removal of particulates and dust.

In some embodiments of the filter medium of the invention, the medium comprises a combination of a metal oxide and a metal hydroxide.

In some embodiments of the invention, the metal oxide component, as a single component or as a mixture of two or more metal oxides, metal hydroxides or combinations thereof, constitutes between about 3 and 20% of the total weight of the filter medium, more preferably between 7 and 15%, and most preferably between 7 and 10% of the total weight of the medium.

In other embodiments, the metal oxide/hydroxide or mixture thereof, as any other component of the filter media, may be segregated from other components of the filter medium in a separate compartment of the filter or filtering unit. Preferably, the separate compartment is placed at the lower part of the filter or filtering unit. In such embodiments, the metal oxide, e.g., iron oxide, may constitute between 50% to 100% of the medium in the separate compartment. When passing water through the filter medium of the invention, thereafter through the compartment holding the metal oxide or particles containing thereof as defined herein, an efficient removal of arsenic and other trivalent ions is achieved.

Thus, in some embodiments the integrated filter medium comprises carbonaceous material, chitosan and/or an ion exchanger and metal oxide which is segregated in a separate compartment of the filter or filtering unit.

Chitosan is a chitin-derived natural biopolymer which has a high content of amine (—NH₂) functional groups. The inherent ability of chitosan to generate small electrical charges has provided benefits in the processing of contaminated liquids. Chitosan has been found to have high binding capacities, normally greater than 1 mM metal per every gram of chitosan for many heavy metal ions, including Cd, Hg, Pb, Cu and others. Without wishing to be bound by theory, the good performance of chitosan in adsorbing heavy metal ions may be attributed to the capability of the amine group of chitosan to form surface complexes with many heavy metal ions in aqueous solutions.

The filter medium may comprise insoluble chitosan selected from chitosan itself (which is a deacetylated chitin that is typically more than about 50% deacetylated), salts of chitosan, chitosan-gel, modified chitosan or mixtures of these. Non-limiting examples of modified chitosans are chitosan acetate, chitosan lactate, chitosan glutamate, methyl-chitosan, and N-carboxymethylchitosan. Mixtures of chitosan salt powders with modified chitosan gels (obtained by adding the chitosan into a weak acid), particularly chitosan salts, may also provide good molding and casting properties to the filter medium.

The molecular weights of the chitosans employed in the medium of the present invention typically range from 5 to about 5,000 KDa. The level of deacetylation of the chitosan is generally not critical to the claimed invention, and chitosan of any degree of deacetylation available on the market may generally be used. However, the chitosan selected should not exhibit substantial expansion or shrinkage when combined with the contaminants in the filtered liquid.

In order to avoid residual taste and/or odor and provide a high quality filter medium for human use, highly pure chitosan is preferably used. To avoid any release of chitosan into the filtered liquid, in some preferred embodiments the chitosan is crosslinked. Crosslinking of chitosan is typically achieved in solution in the presence of a crosslinking agent such as glutaraldehyde.

However, as the crosslinking between the chitosan and a crosslinking agent such as glutaraldehyde produces hydrolizable imine groups, which can break upon exposure to water and thereby permit the leaching out of chitosan into the filtered liquid medium, the risk of obtaining a chitosan-contaminated filtered liquid remains. Thus, to further reduce the risk of chitosan leakage, solid balk chitosan, prepared by thermal crosslinking, is used. This balk chitosan, preferably in the form of flakes of various sizes and shapes has substantially no solubility in water.

According to the present invention, the balk chitosan is prepared by heating chitosan flakes to temperatures above 100° C. for periods ranging from a few minutes to a few hours. This heating process dramatically reduces the solubility of chitosan under acidic conditions where the degree of crosslinking is a function of the temperature applied and duration of heating. For example, heating at 150° C. for 15 minutes forms insoluble chitosan, extending the time up to 24 hours intensifies the crosslinking but the chitosan becomes slightly brown. However, this process does not affect the absorption capacity and selectivity of the treated chitosan. Further crosslinking of chitosan may be achieved by adding a crosslinker to either the chitosan solution or to the solid flakes which crosslinks mainly the chitosan chains on the surface of the flakes. Such crosslinking agents include molecules or polymers possessing two or more aldehyde groups, isocyanates, anhydrides, acid halides, reactive silicone groups and other multifunctional molecules that can bind to the hydroxyl and/or amino groups.

Alternatively, water-insoluble chitosan may be obtained by partial alkylation or acylation of the amino or hydroxyl groups even without crosslinking. For example, chitosan may be reacted with monoaldehydes such as benzaldehyde, hexanal, or octanal (with or without a further reduction), or such agents as alkanoic acids, anhydrides or acyl chlorides such as acetic anhydride or acetyl chloride or alkyl isocyanates to hydrophobize the chitin and reduce its solubility in acidic media.

The water-insoluble chitosan employed may be in the form of flakes, beads, fibers, fabric, non-woven fabrics, porous particulates, and/or powder. In one preferred embodiment, the chitosan employed is in the form of randomly shaped flakes.

The chitosan is preferably added to the medium in an amount ranging from about 1 to about 20%, more preferably from about 2 to about 10%, and most preferably about 4% by weight based on the total weight of the medium.

In one embodiment, the chitosan is modified chitosan.

In another embodiment, the chitosan is a crosslinked chitosan.

In another embodiment, the chitosan is a thermally crosslinked chitosan.

The filter medium may comprise chitosan as disclosed above and/or at least one ion exchanger selected to effectively remove metal ions from the water being filtered. In some embodiments, the medium of the invention comprises a carbonaceous material, a particulate metal oxide/hydroxide material, chitosan and at least one ion exchanger. In other embodiments, the medium comprises a carbonaceous material, a particulate metal oxide/hydroxide material, and at least one ion exchanger.

As a person skilled in the art would realize, an “ion exchanger”, or “ion exchange agent” is an agent capable of exchanging ions present in a medium, e.g., aqueous medium. The ion exchanger may be a cation exchange agent, an anion exchange agent, or a mixture of two such ion exchange agents.

In some embodiments, the filter medium of the invention comprises at least one cation exchange agent. The cation exchange agent is typically a component having acid groups and potassium or sodium ions which provide a high buffering capacity, keeping the passing medium at a desired pH around 7.

The cation exchange agent is preferably a resin, e.g., in the form of beads, flakes or other physical structures, operated in the hydrogen form, to remove dissolved positively charged ions, such as cadmium (Cd⁺²) and other heavy metal ions, copper, lead, mercury, and chromium. Such ions are exchanged for their hydrogen ion (H⁺) equivalent, from the water.

The cation exchange agents are preferably strongly acidic cation exchange agents such as organic compounds having sulfonic or sulfuric acid substituents. Preferably, the strong acid ion exchange has at least 10% of its active groups, e.g., sulfonic acid groups, in their potassium or sodium salt form.

In some embodiments, the ion exchange agent is in the form of polystyrene beads having at least one or more of sulfate acid, potassium sulfate, carboxylates, phosphates, and hydroxamates functionalities and other such functionalities selected to have affinity to metal ions, particularly heavy metal ions, and in some embodiments cadmium metal ions.

In certain embodiments of the invention, when the filter medium comprises the cation exchange agent, it will constitute about 20% to 50% of the total weight of the formulation, more preferably from about 25% to about 40%, most preferably about 30%, by weight based on the total weight of the medium.

In another embodiment, the filter medium further comprises at least one additional agent capable of anion exchange. Typically, the anion exchange agents are added in order to enhance the removal or exchange of ions or selectively remove or exchange a particular ion, such as iron, arsenic and manganese.

In further embodiments of the invention, the filter medium comprises at least one additive selected to have antimicrobial abilities and other components for removal of specific contaminants, such as for example arsenic, as may be necessary.

The filter medium of the invention should preferably comprise a suitable amount of each of the components, i.e., carbonaceous material, particulate chitosan and/or ion exchanger and a particulate metal oxide, wherein the suitable amount is capable of reducing contaminant concentrations to the required minimum. A person skilled in the art would have the knowledge to vary the amounts of each of the components in such a way to affect a reduction in the concentration/volume/distribution/effectiveness/toxicity of a particular contaminant, e.g., heavy metal ions, dissolved organic agents, etc.

The additive selected to have antimicrobial abilities is typically an antimicrobial agent which is selected in a non-limiting fashion amongst iodinated medium, quaternary ammonium resins, antibacterial polymers, such as polymers belonging to the class of cationic polyelectrolytes, polymers possessing quaternary or tertiary ammonium groups and polymers loaded with iodine or iodophors, and other antimicrobial agents as may be known to a person skilled in the art.

In one preferred embodiment, said antimicrobial agent is at least one iodine containing medium.

In another preferred embodiment, said antimicrobial agent is at least one iodinated quaternary ammonium resin.

The antimicrobial agent typically constitutes between 0.1% and 30% of the total weight of the filter medium, more preferably between 2% and 15%, and most preferably between 4% and 12% of the total weight of the medium.

In some embodiments, the antimicrobial agent is separated from the filter medium by segregating it in a compartment of the filter or filtering unit. Preferably, the separate compartment is placed above the filter or filtering unit. In such embodiments, the antimicrobial agent may constitute between 2% to 15% of the medium in the separate compartment. When passing water through the compartment holding the antimicrobial agent and thereafter through the filter or filtering unit containing the filtering medium as defined herein, an efficient removal of microbial, e.g., bacterial contaminants, is achieved.

In another embodiment the antimicrobial agent, placed in a separate compartment of the filer or filtering unit is an iodine-releasing agent which exerts its antimicrobial activity in solution. The iodine-releasing agent may for example be a polyamide (Nylon) fabric loaded with iodine from which iodine is slowly released into the filter medium, thereby exerting its antimicrobial activity. When such iodine-release agents are used, the need arises for an iodine-scavenging agent which would have the capability of removing from the filtered liquid, prior to exiting the filtering unit, any free iodine.

Non-limiting examples of such iodine-scavenging compounds are carbon, aromatic and aliphatic polyamides, polyurethanes, poly(urea), polymers having amino groups, polyvinyl pyrrolidone, polypyrroles and polymers having nitrogen heterocyclic residues and copolymers or blends thereof.

In one embodiment, the iodine-scavenging compound is an agent selected amongst aromatic or aliphatic polyamide, said agent being preferably in the form of a fabric or screen.

In other embodiments of the invention, the filter medium comprises at least one additive selected from sand, gravel, perlite, vermiculite, anthracite, diatomaceous soil, zeolithes, soil, chitin, pozzolan, lime, marble, clay, double metal-hydroxides, rockwool, glass wool, limed soil, iron-enriched soil, bark, humus, compost, crushed leaves, alginate, xanthate, bone gelatin beads, moss, wool, cotton, plant fibres, or any combination thereof.

The contaminants or pollutants referred to herein are any inorganic, organic or mixed inorganic-organic particles, colloidal particles, and solutes and other compounds, as well as microorganisms and other organisms, dead or alive that may be present in the liquid to be filtered. Non-limiting examples of such contaminants are hydrocarbons; polyaromatic hydrocarbons; chlorinated fluids, particularly organic chlorides; oil; heavy metals and other metals such as copper, chromium, cadmium, nickel, iron, lead, and zinc, as free ions, in complexes, as part of a larger molecule, or attached to suspended solids and/or colloidal particles; hormones; pesticides; paint; pharmaceuticals; nutrients such as ammonium, nitrite, nitrate, phosphate, or sodium in inorganic or organic, dissolved or solid forms; humus; soil colloids; clay particulates; other organic and/or inorganic colloidal particles; silt and/or fine and/or medium or coarse sand and/or other small particles; microorganisms such as bacteria, viruses, cysts, amoeba, and worm eggs, and any product of any contaminant of the above resulting from degradation, hydrolysis and/or oxidation thereof.

The filter medium of the invention may thus be used for ridding any liquid of any substance dissolved or suspended therein. The liquid to be filtered is any liquid, preferably water containing. Non-limiting examples of such liquids are water; storm water runoff, including urban runoff, highway runoff and other road runoff; sewage storm water overflow; seawater; natural water sources such as streams, ponds and waterfalls; drinking water; water for agricultural purposes; industrial water for high purity processes; and water-containing solutions suited for foods and beverages.

The filter medium is suitable for the filtration of such liquids for a great variety of purposes, such as filtering drinking water to be used in restaurants, hotels, homes, food processing plants, and business facilities of various types; pre-treating water for bottled water plants; filtering groundwater contaminated with metals, metal salts, insoluble matter, organic agents, pesticide, chlorinated compounds, natural toxins or otherwise contaminated groundwater; filtering of industrial liquid waste water; filtering of drinking water sources prior to delivery to human consumption; removal of suspended solids from surface water; remediation of natural aquatic environments, such as polluted lakes, streams or rivers; and reduction in concentration of a certain agent, e.g. electrolyte from said liquid and replacement thereof by another.

The filter medium may also be employed in the treatment of swimming pools, hot tubs, spas, ponds, cooling water systems, humidification systems, fountains, and the like. The filter medium and/or the water treatment system containing it, as disclosed hereinbelow, is desirably placed in the water or in the path of the water stream in a way that will maximize the amount of water that comes into contact with the medium. In one embodiment, the medium is placed in the water in such a way that forced or natural currents or flow of the water brings water into contact with the filter medium. In a swimming pool, hot tub, or spa, the medium may be placed in the skimmer trap. Alternatively, it may be placed near a pump outlet, so that re-circulated water is continuously discharged near the medium and comes into contact with it.

In another aspect of the invention, there is provided a filter medium consisting of water-insoluble carbonaceous material, water-insoluble metal oxide, and water-insoluble chitosan and/or ion exchanger.

In yet another aspect of the invention there is provided a filter medium consisting of water-insoluble carbonaceous material, water-insoluble metal oxide, water-insoluble acidic cation exchange agent, and/or water-insoluble chitosan.

In still another aspect of the invention there is provided a filter medium consisting of water-insoluble carbonaceous material, water-insoluble metal oxide, water-insoluble acidic cation exchange agent, antimicrobial agent and/or water-insoluble chitosan.

In still another aspect of the present invention there is provided a filtering unit comprising: the filtering medium of the invention; and a liquid channeling structure for directing a liquid entering an input of the filtering unit to flow through the filtering medium before exiting an output of the filtering unit.

The filter medium may be contained in a container to form the filtering unit or a water treatment system. The container can assume a variety of forms, provided that at least one water inlet opening and one outlet opening are present. The container may be simply a pipe or an irregularly shaped container having the filter medium disposed inside, with open ends, and optionally with some means for keeping the medium relatively immobilized within the container. For instance, the filtering unit or the water treatment system may contain one or more screens, mesh, baskets, webs or baffles that prevents large particles or pieces of the medium from passing through, and keeps them within the container. Alternatively, the filter medium may be held together by using a binder.

The container may be in the form of a multilayer or multi-chamber container, having each of the components of the filter medium contained in a separate chamber (compartment, holding unit), or contained as a mixture in a single chamber. The chambers may be separated from each other by a variety of dividers such as screens, mesh, baskets, webs or baffles that prevent particles or pieces of the medium from passing from one chamber to another or outside of the container.

In some embodiments, the filter medium of the invention is arranged in layers, vertically—one on top of the other, or horizontally—one to the side of the other, with each component contained in a separate compartment.

In one embodiment, the compartments are arranged vertically or horizontally, in the direction of the water flow, the component of the filter medium contained in a compartment closest to the water input is at least one of a carbonaceous material, a metal oxide or hydroxide, a chitosan and/or an ion exchanger. The component of the filter medium contained in a compartment being the furthest from said water input is at least one of a carbonaceous material, a metal oxide or hydroxide, a chitosan and/or an ion exchanger.

In some embodiments, said layers are arranged with said polystyrene beads, contained in a compartment closest to the water input.

In some other embodiments, the polystyrene beads are contained in a compartment being closest to the water input, is positioned in a filtering system next to a compartment containing at least one carbonaceous material impregnated with Ag.

In some other embodiments, said compartment containing said at least one carbonaceous material impregnated with Ag is positioned in a filtering system next to a compartment containing polysterene beads with iminodiacetic functional groups.

In some further embodiments, the compartment containing iron oxide nanoparticles embedded in polysterene beads is positioned in a filtering system at a point closest to the water output of a filtering system.

In further embodiments, said compartments are layers of the filter medium components, positioned in relation to each other as detailed herein.

In one embodiment, the components of the filter medium are arranged in relation to each other, e.g., from top to bottom, with the first component listed below being closest to the water input:
polystyrene beads, e.g., with sulfate acid and potassium sulfate functionalities,
carbonaceous material, e.g., impregnated with Ag,
polysterene beads, e.g., with iminodiacetic functional groups, and at the bottom
iron oxide nanoparticles, e.g., embedded in polysterene beads.

In yet another embodiment, the components of the filter medium are arranged in relation to each other, e.g., from top to bottom, with the first component listed below being closest to the water input:
carbonaceous material, e.g., impregnated with Ag,
polysterene beads, e.g., with iminodiacetic functional groups,
carbonaceous material, e.g., impregnated with Ag, and at the bottom
iron oxide nanoparticles, e.g., embedded in polysterene beads.

In still another aspect of the invention, there is provided a method for the preparation of a blend filter medium of the invention, said method comprising mixing the solid particulate components of the filter medium in the appropriate amounts to preferably form a homogeneous blend. For example, the activated carbon can be added in an amount of 30 to 75%, preferably between 50 and 70%, more preferably between 55 and 65% of the total weight of the medium; a metal oxide can be added in an amount of 3 to 20%, preferably between 7 and 15%, and most preferably 10% of the total weight of the medium; a chitosan or an ion exchanger can be added in an amount of 1 to 20%, more preferably from about 2% to about 10%, most preferably about 4% by weight based on the total weight of the medium; optionally the ion exchanger is a strong acid cation exchange agent added in an amount of 20 to 50%, more preferably from about 25 to about 40%, most preferably about 30%, by weight based on the total weight of the medium.

In some embodiments, the filter medium does not comprise chitosan.

The medium components may be added in any order and then be blended to form a homogeneous blend using known and readily available mixing equipment and techniques, such as Mixmullers, Hobart mixers, and the like.

In another aspect of the present invention, there is provided a commercial package (kit) comprising the filter medium of the invention, instructions for use and optionally any other component or additive as disclosed herein.

The commercial package may be suited for the specific application, for example depending on the type of the filtering system in which the filter medium is to be mounted, the type of contaminants known to exist in the liquid to be filtered, the volume of the liquid to be filtered and the like.

The commercial package may contain the filter medium in a ready-for-use form, namely in a form which for example may be mounted by the end user or by a technician in the filtering system.

The commercial package may also contain, in the same package or a different package for use with the filter medium of the invention, at least one of the additives disclosed herein. The commercial package may contain the filter medium of the invention already mixed with at least one of said additives or additional components, e.g., acidic cation exchange agent, additional anion exchange agents, etc.

### BRIEF DESCRIPTION OF THE DRAWINGS

In order to understand the invention and to see how it may be carried out in practice, a preferred embodiment will now be described, by way of non-limiting example only, with reference to the accompanying drawings, in which:

FIGS. 1A-1B demonstrate the ability of an exemplary filter medium of the invention in removing heavy metal ions as percent entry concentration after filtration of 5 liters of tap water (n=3).

FIGS. 2A-2B demonstrate the ability of an exemplary filter medium of the invention in removing heavy metal ions as percent entry concentration after filtration of 90 liters of tap water (n=3).

FIGS. 3A-3B demonstrate the reduction of several volatile and semi-volatile organic chemicals after filtration at 5% capacity (FIG. 3A) and 90% capacity (FIG. 3B).

FIG. 4 demonstrates the antibacterial effect of polyethylene imine within 20 minutes of exposure.

FIG. 5 demonstrates the antibacterial effect of 4-vinyl pyridine octane.

FIG. 6 demonstrates the biological activity of iodine released from nylon fabric.

FIG. 7 demonstrates the accumulation of iodine released from the matrix.

FIG. 8 demonstrates the number of colonies before and after filtration with iodine loaded fabric.

FIG. 9 demonstrates the iodine concentration dependency on the amount of the water filtered.

### DETAILED DESCRIPTION OF EXEMPLARY EMBODIMENTS

### Example 1

### Preparation of a Filter Medium

Basic integrated filter (herein referred to as filter A) contains activated carbon impregnated with 1.05% silver (35 g), cationic exchangers based on crosslinked polystyrene containing sulfonic acid groups with 40% of its acidic groups present as potassium salt (14 g) and chitosan flakes (2 g). The tested filters were prepared by mixing the components and filling the mixture in the appropriate filter holders. The filters were initially washed with 2 liters of water prior to use. The filter was tested for its effectiveness in removing inorganic and organic contaminants.

pH adjustment—One-liter samples of tap water at pH 5 and 9 (pH adjusted by using HCl and NaOH as needed) were filtered through the basic integrated filter (filter A). The pH after filtration was between 6.8 and 7.4. The pH after filtration through a commercial filter, produced by Brita and purchased in a local store (containing a mixture of carbon and sulfonated ion exchange agent, herein designated filter H) was significantly lower, between 5.5 and 6.

Removal of organic color contaminants—the contribution of chitosan—The contribution of chitosan to the filtration efficiency was tested by using the basic integrated filter (filter A) without chitosan flakes. Positively charged Brilliant Cresyl Blue (500 ml, 30 mg/L solution) and negatively charged calconcarboxylic acid (500 ml, 50 mg/L solution), used as color contaminants were prepared and filtered through the basic integrated filter (filter A), basic integrated filter without chitosan and commercial filter (filter H). Concentrations of the color contaminants before and after filtration were measured by a spectrophotometer at 610 nm for Brilliant Cresyl Blue and 570 nm for Calconcarboxylic acid and calculated from previously prepared calibration curves.

The basic integrated filter (filter A) eliminated >96% of the positively charged colored contaminants and >96% of the negatively charged colored contaminants, while the commercial filter (filter H) eliminated about 96% of the positively charged colored contaminants but only 10.8% of the negatively charged colored contaminants. The basic integrated filter without chitosan (filter A w/o chitosan) eliminated 91.0% of the positively charged colored contaminants and 57% of the negatively charged colored contaminants.

Reduction of metal contamination—Various filter media were prepared by adding specially designed components to the basic integrated filter (filter A). The various filter media were:

Filter B contained activated carbon impregnated with 1.05% silver (35 g), a cationic exchanger based on crosslinked polystyrene containing sulfonic acid groups with 40% of its acidic groups present as potassium salt (14 g) and a chelating resin commercially available (from Purolite) under the trade name A-606 (2 g). A-606 is a macroporous polystyrene-based chelating resin with trimethylammonium groups at the para-position. In this example, A-606 served as a substitute for chitosan. This medium absorbed organic and inorganic anionic contaminants.

Filter C contained activated carbon impregnated with 1.05% silver (35 g), a cationic exchanger based on crosslinked polystyrene containing sulfonic acid groups with 40% of its acidic groups present as potassium salt (14 g), chitosan flakes (2 g) and an ion exchange resin commercially available (from Purolite) under the trade name ArsenX^{np} (5 g). ArsenX^{np} is an ion exchange resin loaded with iron oxide particles which serves as a chelating resin designed to remove trivalent, tetravalent and pentavalent metal ions such as arsenate and arsenite from water. The chemical structure is hydrous iron oxide nanoparticles based on polystyrene crosslinked with divinyl benzene (DVB).

Filter D contained activated carbon impregnated with 1.05% silver (35 g), a cationic exchanger based on crosslinked polystyrene containing sulfonic acid groups with 40% of its acidic groups present as potassium salt (14 g), chitosan flakes (2 g) and a chelating resin commercially available (from Purolite) under the trade name S-950 (5 g). S-950 is a macroporous amino-phosphonic acid chelating resin designed for removal of cations of toxic metals as lead, copper and chromium. S-950 is a macroporous polystyrene crosslinked with DVB having active amiophosphonic acid groups.

Filter E contained activated carbon impregnated with 1.05% silver (35 g), a cationic exchanger based on crosslinked polystyrene containing sulfonic acid groups with 40% of its acidic groups present as potassium salt (14 g), chitosan flakes (2 g), S-950 (5 g) and ArsenX^{np} (5 g).

Filter H is a commercial filter produced by Brita, purchased in a local store and was usually used as a control for the studies disclosed herein. This filer contained a mixture of activated carbon and ion cationic exchanger.

Six different test solutions containing metal ions were prepared using Merck ICP multi-element standard solution IV, Merck ICP arsenic standard solution, ZnCl₂ and FeCl₃, as shown in Table 1.

TABLE 1
Preparation of test solutions.

| | | | Concentration |
|---|---|---|---|
| | Ingredient | Preparation | (ppm) |
| 1 | Orange ICP std 100 ppm | 0.6 ml/2 L | 0.03 |
| 2 | Orange ICP std 100 ppm | 3 ml/2 L | 0.15 |
| 3 | Orange ICP std 100 ppm | 6 ml/2 L | 0.3 |
| 4 | As ICP std 1000 ppm | 0.1 ml/2 L | 0.05 |
| 5 | ZnCl dehydrate | ~1 gr/50 ml >> 2 ml/2 L | ~10 |
| 6 | FeCl₃ dehydrate | 726 mg/50 ml >> | ~3-5 |
| | | 2 ml/2 L | |

Each test solution (250 ml) was filtered through the above filters (filters A to E and filter H). The filters were washed with 0.5 L of deionized water after each test solution. Samples (50 ml) of before and after filtration were collected to sterile plastic tubes and nitric acid (0.5 ml 70% w/w) was added to each sample to pH=2. During two weeks, 90 liters of tap water was filtered through the tested filters and working procedures were repeated. The collected samples were tested using ICP procedure and equipment.

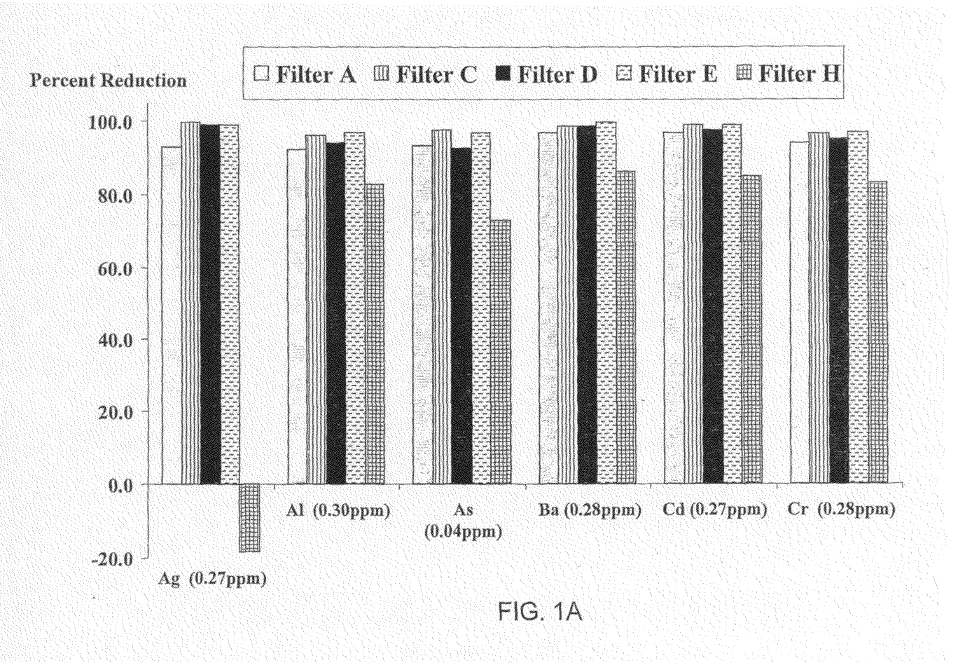

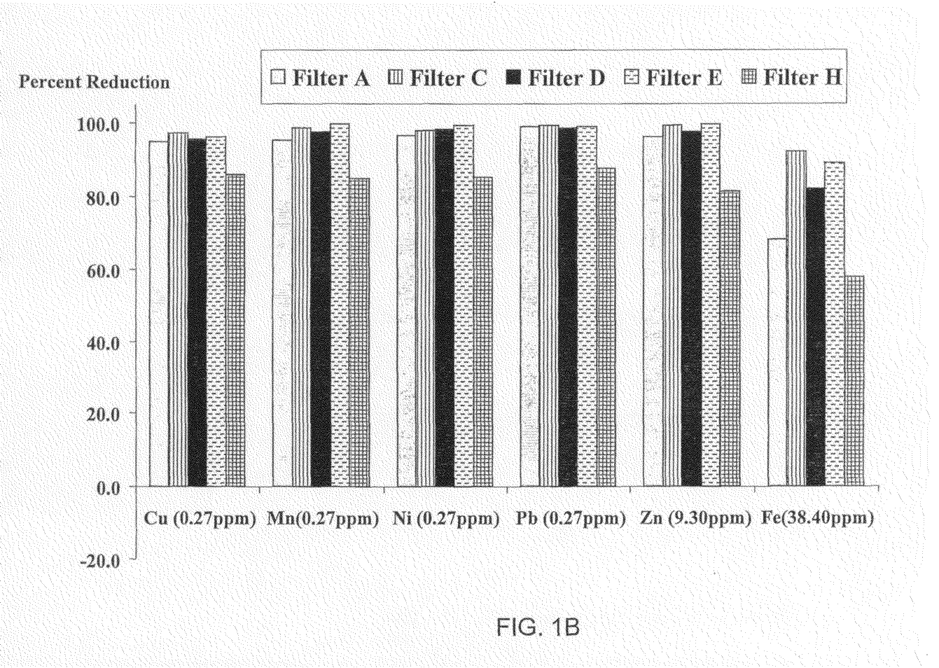

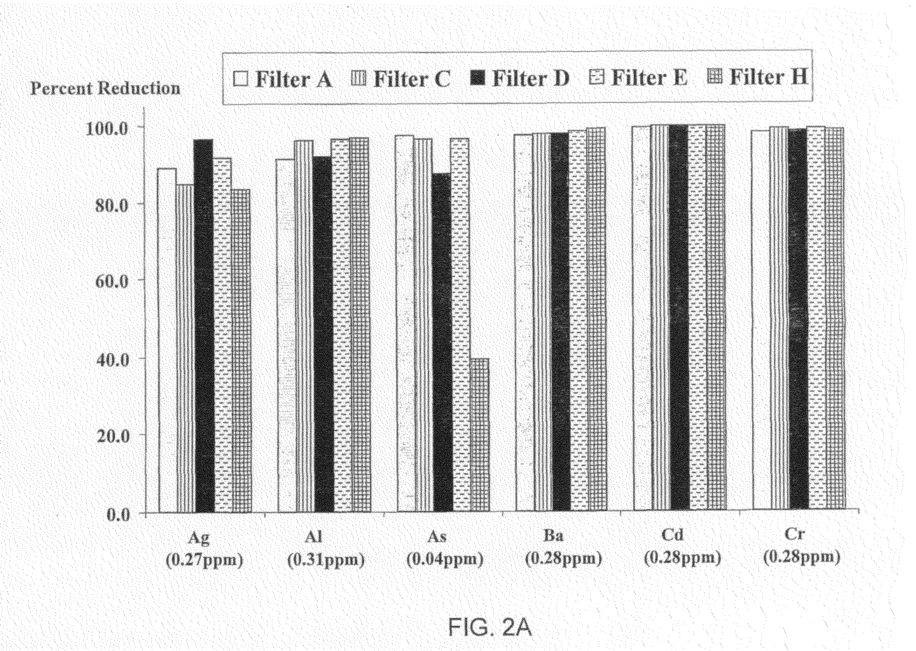

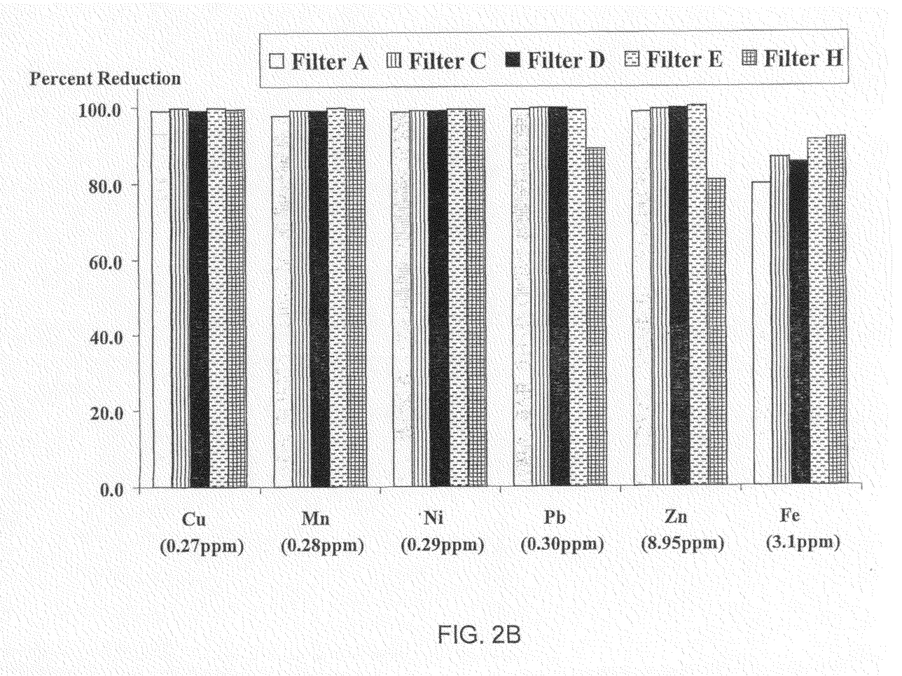

The results of this experiment are presented in Table 2 below and in FIGS. 1A-1B and 2A-2B.

TABLE 2
Reduction of Metal Contamination after Filtration
Reduction of metal contamination after filtration

| | | | | | | | Effluent (ppm) |
|---|---|---|---|---|---|---|---|
| | Influent | Effluent | Effluent | Effluent | Effluent | Effluent | Commercial |
| Filter | (ppm) | (ppm) A | (ppm) B | (ppm) C | (ppm) D | (ppm) E | filter H |
| Ag | 2.31E−02 | 1.37E−02 | 2.43E−02 | 0.00E+00 | 0.00E+00 | 0.00E+00 | 4.75E−02 |
| | 1.39E−01 | 1.34E−02 | 5.71E−02 | 2.83E−03 | 2.77E−03 | 4.07E−03 | 1.56E−01 |
| | 2.70E−01 | 1.89E−02 | 2.84E−02 | 8.00E−04 | 2.93E−03 | 2.83E−03 | 3.19E−01 |
| As | 4.14E−02 | 2.70E−03 | 1.23E−03 | 9.33E−04 | 2.97E−03 | 1.17E−03 | 1.08E−02 |
| Ba | 2.83E−02 | 1.60E−03 | 5.00E−04 | 1.67E−03 | 1.20E−03 | 3.67E−04 | 1.90E−03 |
| | 1.42E−01 | 4.47E−03 | 2.01E−02 | 1.33E−03 | 1.67E−03 | 6.00E−04 | 9.17E−03 |
| | 2.75E−01 | 8.37E−03 | 4.47E−03 | 3.80E−03 | 4.07E−03 | 8.00E−04 | 3.81E−02 |
| Cd | 2.76E−02 | 1.40E−03 | 7.83E−04 | 4.67E−04 | 6.67E−04 | 5.67E−04 | 1.35E−03 |
| | 1.41E−01 | 3.68E−03 | 2.11E−02 | 9.83E−04 | 2.07E−03 | 1.38E−03 | 9.88E−03 |
| | 2.67E−01 | 8.52E−03 | 5.90E−03 | 2.90E−03 | 6.72E−03 | 2.35E−03 | 4.02E−02 |
| Cr | 2.96E−02 | 3.00E−03 | 4.20E−03 | 3.60E−03 | 4.20E−03 | 3.97E−03 | 2.50E−03 |
| | 1.45E−01 | 9.03E−03 | 2.45E−02 | 6.70E−03 | 9.87E−03 | 7.10E−03 | 1.32E−02 |
| | 2.78E−01 | 1.66E−02 | 1.51E−02 | 1.01E−02 | 1.36E−02 | 8.40E−03 | 4.65E−02 |
| Cu | 1.38E−01 | 7.80E−03 | 1.93E−02 | 4.93E−03 | 5.97E−03 | 6.93E−03 | 9.60E−03 |
| | 2.65E−01 | 1.32E−02 | 7.03E−03 | 7.03E−03 | 1.20E−02 | 9.77E−03 | 3.84E−02 |
| Fe | 3.15E−02 | 1.04E−02 | 2.36E−02 | 1.04E−02 | 2.73E−03 | 1.11E−02 | 2.11E−02 |
| | 1.51E−01 | 2.02E−02 | 5.57E−02 | 1.45E−02 | 3.17E−02 | 1.26E−02 | 2.52E−02 |
| | 2.85E−01 | 3.83E−02 | 2.86E−02 | 1.80E−02 | 2.85E−02 | 1.60E−02 | 6.74E−02 |
| | 3.84E+01 | 1.22E+01 | 5.46E+00 | 3.01E+00 | 6.83E+00 | 4.19E+00 | 1.61E+01 |
| Mg | 5.20E−02 | 4.03E−02 | 3.86E−02 | 2.74E−02 | 2.80E−02 | 2.39E−02 | 2.25E−02 |
| | 1.66E−01 | 4.68E−02 | 8.61E−02 | 2.73E−02 | 4.34E−02 | 2.27E−02 | 2.79E−02 |
| | 2.95E−01 | 7.86E−02 | 5.42E−02 | 4.16E−02 | 3.73E−02 | 2.66E−02 | 6.47E−02 |
| Mn | 2.82E−02 | 1.97E−03 | 7.33E−04 | 5.00E−04 | 5.33E−04 | 3.00E−04 | 1.40E−03 |
| | 1.43E−01 | 5.17E−03 | 2.32E−02 | 6.33E−04 | 1.90E−03 | 6.00E−04 | 1.05E−02 |
| | 2.74E−01 | 1.29E−02 | 7.37E−03 | 3.77E−03 | 5.73E−03 | 9.00E−04 | 4.11E−02 |
| Ni | 2.76E−02 | 1.37E−03 | 9.33E−04 | 4.33E−04 | 4.67E−04 | 6.67E−05 | 1.10E−03 |
| | 1.40E−01 | 3.53E−03 | 2.12E−02 | 2.00E−04 | 2.03E−03 | 1.33E−04 | 9.73E−03 |
| | 2.66E−01 | 8.67E−03 | 5.00E−03 | 5.00E−03 | 4.53E−03 | 1.00E−03 | 3.98E−02 |
| Pb | 2.48E−02 | 0.00E+00 | 6.00E−04 | 2.00E−04 | 1.67E−04 | 5.00E−04 | 0.00E+00 |
| | 1.43E−01 | 4.00E−04 | 1.42E−02 | 1.53E−03 | 2.27E−03 | 9.00E−04 | 5.00E−03 |
| | 2.72E−01 | 1.93E−03 | 1.87E−03 | 1.57E−03 | 2.97E−03 | 2.20E−03 | 3.30E−02 |
| Zn | 1.39E−01 | 1.87E−02 | 6.80E−02 | 5.10E−03 | 9.57E−03 | 3.60E−03 | 1.22E−02 |
| | 2.66E−01 | 3.03E−02 | 2.24E−02 | 1.52E−02 | 1.75E−02 | 5.30E−03 | 4.26E−02 |
| | 9.28E+00 | 3.33E−01 | 1.92E−01 | 5.02E−02 | 2.21E−01 | 1.56E−02 | 1.74E+00 |

The differences between the basic integrated filter (filter A) and the commercial filter (filter H) were significant at high influent concentrations: 99% and 88% reduction of lead, 96.8% and 85.1% reduction of cadmium, 97% and 86.4% reduction of barium were obtained after using filter A and H, respectively, as shown in FIGS. 1A-1B.

As shown in FIGS. 2A-2B, chelating resins S-950 and ArsenX^{np} enhanced the reduction of arsenic, barium, copper, cadmium and zinc. The reduction of arsenic after filters C and D was 98% and 93%, respectively, as compared with 93% reduction after filter A. The reduction of cadmium after filters C, D and E was 99%, 97% and 99%, respectively, as compared with a 97% reduction obtained with filter A.

Filter H released silver ions to water, and so silver concentration was increased by 10% at high influent concentrations.

There were no significant differences between basic filter A and filters C, D and E containing metal chelators at 90% capacity (FIGS. 2A-B). Reduction of barium at 90% capacity was 97.5%, 98%, 97.9% and 98.5% after filters A, C, D and E, respectively.

In general, the basic integrated filter (filter A) remained effective in reducing concentrations of cadmium, chromium, copper, nickel and lead at 90% capacity. There was 97% and 99% reduction of cadmium after filter A at 5% and 90% capacity, respectively, and 99.3% reduction of lead after filter A at both capacities (FIGS. 2A-B and 3A-3B). Commercial filter H remained effective also at 90% capacity and was even more effective in reduction of cadmium, chromium and copper than at 5% capacity.

Removal of volatile, semi-volatile organic chemicals and pesticides—Water solutions containing volatile organic compounds (VOC's) such as benzene (300 mg/L), iodobenzene (193 mg/L) and allyl bromide (108 mg/L) were prepared. Each solution (1 liter) was filtered through filters A and H and VOC concentrations before and after filtration was measured by a spectrophotometer at 254 nm for Benzene and 240 nm for iodobenzene and allyl bromide.

Water solutions containing pesticides such as N,N-diethyltoluamide (115 mg/L) and piperonyl butoxide (108 mg/L) were also prepared. Water solutions of hazardous drug compounds such as doxyciline (104 mg/L) were additionally prepared. One liter of each solution was filtered through filters A and H and concentrations before and after filtration were measured by a spectrophotometer at 200-300 nm. N,N Diethyl-toluamide absorbed at 250 nm, piperonyl butoxide at 236 nm and doxicyline at 300 nm.

Results of organic compounds reduction by the tested filters are summarized in Table 3.

TABLE 3
Removal of toxic organic molecules

| Contaminant, conc. | Filter A | Filter H |
|---|---|---|
| before filtration | % Reduction | % Reduction |
| Benzene | 97% | 53% |
| 300 mg/L | | |
| Iodobenzene | >99% | 82% |
| 193 mg/L | | |
| N,N Diethyl-n-toluamide | >99% | 63% |
| 115 mg/L | | |
| Piperonyl butoxide | >99% | 85% |
| 108 mg/L | | |
| Allyl bromide | >99% | 71% |
| 108 mg/L | | |
| Doxicycline | 95% | 72% |
| 104 mg/L | | |

The basic integrated filter (filter A) eliminated 97% of benzene, more than 99% of allyl bromide, while the commercial filter (Filter H) eliminated only 53% of benzene, 71% of allyl bromide, 63% of N,N Diethyl-n-toluamide and 85% Piperonyl butoxide.

In another experiment the efficient removal of volatile organic compounds (VOC) and semi volatile organic compounds (SVOC) was tested. Filters A and B were examined in this study. Filter H was used as a control.

In this experiment, the filters were first washed with 10 litters of tap water. A solution (1.2 L) contained all VOC and SVOC chemicals were filtered through and the compound concentrations before and after filtration were measured by GC-MS. The procedure was performed after filtration of 5 liters and 90 liters of water through filters A, B, and H.

Tables 4 and 5 present the results that were obtained in this study.

TABLE 4
Removal of semi volatile organic compounds (SVOC)

| | | | Effluent |
|---|---|---|---|
| | | | Commercial |
| | Influent | Effluent Filter A | filter H |
| Semivolatiles | mg/L | mg/L | mg/L |
| bis-(2- | 0.156 | 0.003> | 0.011 |
| Chloroethyl)ether | | | |
| 2,2′-oxybis(1- | 0.149 | 0.003> | 0.011 |
| Chloropropane) | | | |
| Acetophenone | 0.133 | 0.003> | 0.008 |
| N-Nitroso-di-n- | 0.159 | 0.003> | 0.014 |
| propylamine | | | |
| Nitrobenzene | 0.57 | 0.003> | 0.027 |
| Isophorone | 0.225 | 0.003> | 0.019 |
| 2-Nitrophenol | 0.125 | 0.003> | 0.005 |
| 2,4-Dimethylphenol | 0.127 | 0.003> | 0.01 |
| bis-(2- | 0.214 | 0.003> | 0.014 |
| Chloroethoxy)methane | | | |
| 2,4-Dichlorophenol | 0.125 | 0.003> | 0.007 |
| 4-Chloro-3- | 0.121 | 0.003> | 0.01 |
| methylphenol | | | |
| 2,4,6-Trichlorophenol | 0.098 | 0.003> | 0.006 |
| 2,4,5-Trichlorophenol | 0.082 | 0.003> | 0.004 |
| o-Nitroaniline | 0.079 | 0.003> | 0.004 |
| Dimethylphthalate | 0.189 | 0.003> | 0.02 |
| 2,6-Dinitrotoluene | 0.179 | 0.003> | 0.012 |
| 2,4-Dinitrophenol | 0.357 | 0.003> | 0.035 |
| 4-Nitrophenol | 0.068 | 0.003> | 0.004 |
| 2,4-Dinitrotoluene | 0.186 | 0.003> | 0.012 |
| Diethylphthalate | 0.187 | 0.003 | 0.026 |
| 4,6-Dinitro-2- | 0.195 | 0.003> | 0.014 |
| methylphenol | | | |
| N- | 0.101 | 0.003> | 0.007 |
| Nitrosodiphenylamine | | | |
| Di-n-butylphthalate | 0.08 | 0.003> | 0.006 |
| Butylbenzylphthalate | 0.077 | 0.003> | 0.003 |

TABLE 5
Removal of volatile organic compounds (VOC)

| | | | Effluent |
|---|---|---|---|
| | | Effluent | Commercial |
| | Influent | Filter A | filter H |
| Volatiles | mg/L | mg/L | mg/L |
| Methylene Chloride | 0.111 | 0.092 | 0.167 |
| trans-1,2-Dichloroethene | 0.155 | 0.006 | 0.049 |
| Cis-1,2-Dichloroethene | 0.108 | 0.002> | 0.009 |
| Chloroform (THM) | 0.24 | 0.004 | 0.048 |
| 1,1,1-Trichloroethane | 0.292 | 0.005 | 0.063 |
| Carbon Tetrachloride | 0.183 | 0.003 | 0.039 |
| 1,2-Dichloroethane | 0.033 | 0.004 | 0.037 |
| Trichloroethene | 0.237 | 0.002> | 0.029 |
| 1,2-Dichloropropane | 0.101 | 0.002 | 0.026 |
| 1,2,4-Trimethylbenzene | 0.064 | 0.002> | 0.025 |
| 1,3,5-Trimethylbenzene | 0.061 | 0.002> | 0.019 |
| Propylbenzene | 0.15 | 0.002> | 0.035 |
| Bromodichloromethane(THM) | 0.13 | 0.0020 | 0.028 |
| Cis-1,3-Dichloropropene | 0.177 | 0.002> | 0.029 |
| trans-1,3-Dichloropropene | 0.119 | 0.002> | 0.018 |
| 1,1,2-Trichloroethane | 0.137 | 0.003 | 0.025 |
| Tetrachloroethene | 0.153 | 0.003 | 0.089 |
| Dibromochloromethane(THM) | 0.133 | 0.002 | 0.024 |
| 1,2-Dibromoethane | 0.152 | 0.003 | 0.02 |
| Chlorobenzene | 0.158 | 0.002> | 0.012 |
| Xylenes (Total) | 0.193 | 0.004 | 0.086 |
| Styrene | 0.125 | 0.002> | 0.018 |
| Bromoform(THM) | 0.137 | 0.002> | 0.019 |
| Isopropylbenzene | 0.095 | 0.002> | 0.036 |
| 1,1,1,2-Tetrachloroethane | 0.096 | 0.002 | 0.03 |
| 1,3-Dichlorobenzene | 0.099 | 0.005 | 0.033 |
| 1,4-Dichlorobenzene | 0.072 | Not | 0.026 |
| | | detectable | |
| 1,2-Dichlorobenzene | 0.081 | 0.003 | 0.028 |
| 1,2,4-Trichlorobenzene | 0.025 | 0.003 | 0.023 |
| Benzene | 0.052 | 0.002> | 0.023 |
| Toluene | 0.112 | 0.002> | 0.028 |
| Ethylbenzene | 0.075 | 0.002> | 0.03 |

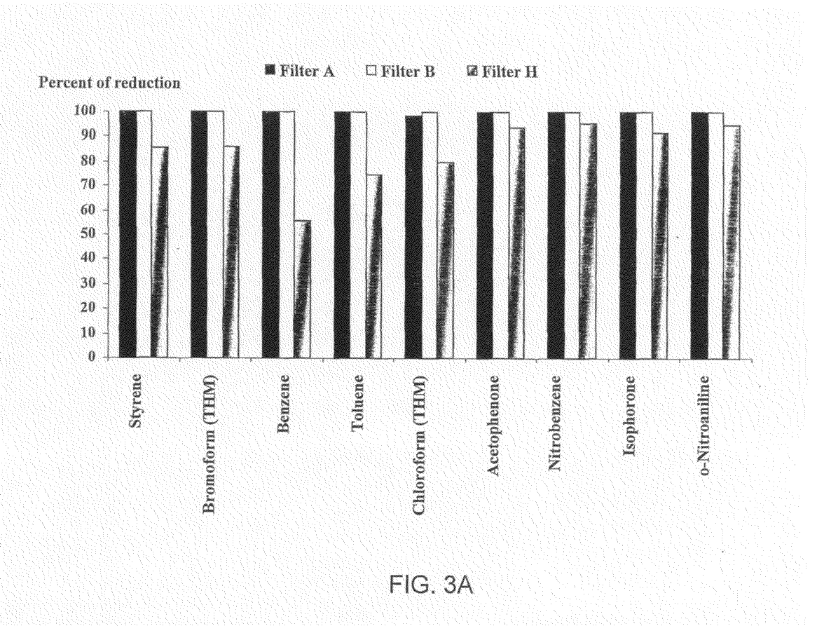

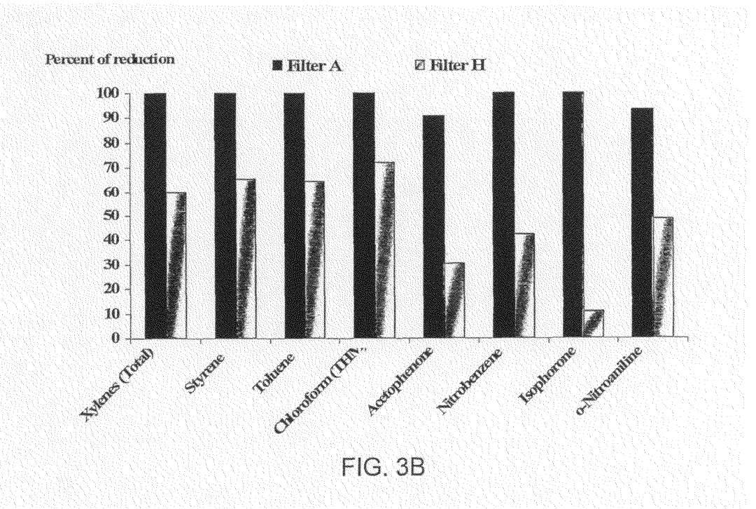

Filters A and B were found to be significantly more efficient in removing both volatile and semi volatile organic chemicals compared to commercial filter H at 90% capacity as at 5% capacity. As FIGS. 3A-3B demonstrate, most of tested volatile and semi-volatile organic chemicals as chlorobenzene, styrene, benzene, toluene, acetophenone, diethylphthalate and nitrobenzene were not detected after filtration through filters A and B at 5% capacity as compared with only 50-85% reduction after filter H. Filter A absorbed more then 97% of xylenes as compared with 55.4% absorption after filter H. Absorption of all tested chemicals at 90% capacity was more efficient by filter A then by filter H.

### Example 2

### Crosslinking of Chitosan

Nine samples of 1 g chitosan each (99% deacetylated) where left in closed glass vials at 150° C. for different periods of time, as follows:

sample no. 1 for 5 min;

sample no. 2 for 10 min;

sample no. 3 for 15 min;

sample no. 4 for 30 min;

sample no. 5 for 45 min;

sample no. 6 for 1.5 hours;

sample no. 7 for 3 hours;

sample no. 8 for 6 hours;

sample no. 9 for 24 hours.

All samples were cooled to room temperature after removal from the oven. For the evaluation of crosslinking between and within the chitosan polymer chains a solubility test was performed, as follows: 100 mg samples of the chitosan of the nine samples in 5 ml 5% acetic acid aqueous solution were mixed at room temperature for 10 min and 60 minutes. As control, 100 mg of the untreated chitosan was dissolved under the same conditions.

Untreated chitosan completely dissolved and gave a homogeneous yellowish solution. Sample nos. 1-2 formed a yellow viscous gel. Sample nos. 3-5 formed an orange hydrogel, sample no. 5 was darker and thicker than sample no. 4. Sample nos. 6-9 showed swollen insoluble particles.

All 9 samples were tested for their capacity in removing organics, including: benzene, toluene, tetrachloromethane, tetrachloroethane and styrene; and metal ions, including: iron, arsenic copper and chromium. All 9 samples showed similar activity in removing these contaminants from water at effluent concentrations recommended by the NSF.

Further crosslinking of the chitosan was achieved by adding a crosslinker to either the chitosan solution or to the solid flakes. In one example, chitosan was treated heterogeneously by reacting the chitosan flakes with a diluted solution of glutaraldehyde where 1 gram of the flakes were dispersed in 20 ml of a 1% glutaraldehyde solution at pH 7.0. The mixing was continued at room temperature for 2 hours and then the flakes were isolated by filtration and dried. The flakes did not dissolve in a 5% acetic acid solution.

Alternatively, chitosan flakes or aqueous solution thereof were treated with an oxidizing agent, preferably potassium or sodium periodate, that partially oxidized the saccharide units to form aldehyde groups along the chitosan polymer chains. These aldehyde groups were self inter- or intra-crosslinked with the amino groups along the chains. In some cases, the formed chitosan polyaldehyde was mixed with intact chitosan to serve as crosslinking agent via imide bonds.

### Example 3

### Alkylation of Chitosan

3 g of chitosan (18.75 mmol, DA=8.2%) dissolved in 150 ml of 1% acetic acid was reacted with 0.75 mmol of glutaraldehyde (0.04 equimolar, 0.3 ml of 25% w/w aqueous solution) which was added dropwise. The mixture was stirred at room temperature for 1 hour. Ethanol (210 ml) and octanal (18.75 mmol, 1 equimolar) were added to the flask. The solution was stirred for 2 hours at room temperature before NaCNBH₃ (2.49 g; 2 equimolar) was added to reduce the imine bonds to amines and the stirring was continued for additional 1.5 hours under the same conditions. White precipitate was obtained during this reduction step. The pH was adjusted to 10 and the product was isolated by filtration. The white powder was washed with several portions of ethanol and water and vacuum-dried over P₂O₅ pellets over night. Average yield: 73% (w/w).

FT-IR (KBr): 1149 cm⁻¹ (C—O), 1460 cm⁻¹ (C—H, aliphatic), 2926 cm⁻¹ and 2854 cm⁻¹ (C—C, aliphatic) and 3420 cm⁻¹ (—NH, —OH groups). No peak in 1595 cm⁻¹ (NH₂) indicated the complete alkylation on nitrogen.

Elemental analysis: % C=59.62 (after alkylation), % C=40.11 (before alkylation).

In the next step, a mixture of 1 g of the aminated chitosan, 2.4 g of sodium iodide, 5 ml of 20% aqueous sodium hydroxide was mixed in 40 ml of N-methylpyrrolidone and stirred at 60° C. for 20 min. 5 ml of methyl iodide was added to the mixture and the reaction was stirred for 1 hour at 60° C. Then additional 2 ml of methyl iodide and 5 ml of 20% aqueous sodium hydroxide were added. The reaction was further continued for another 1 h at 60° C. This procedure was repeated with the same amounts of methyl iodide (2 ml) and 20% aqueous sodium hydroxide solution (5 ml) for another hour at the same conditions. The product was precipitated from solution using water. The yellow product was washed with several amounts of water and vacuum-dried over NaOH pellets over night. Average yield: 1.56 g.

FT-IR (KBr): 1030 cm⁻¹ and 1160 cm⁻¹ (secondary alcohol), 1456 cm⁻¹ (C—H, aliphatic), 2927 cm⁻¹ (C—C, aliphatic) and 3400 cm⁻¹ (OH groups).

Elemental analysis: % I=25.54, % C=44.98.

### Example 4

### Testing of Different Antibacterial Polymers for Biological Water Treatment Applications

Three types of different antibacterial polymer beads were tested for time of maximal effect, mode of action and suitability for incorporation in the integrated filter medium of the invention.

Octyl polyethylene iminium iodide (PEIo) and N-octane 4-vinyl pyridinium chloride (PVPo) are macromolecular quaternary ammonium salts belonging to the class of cationic polyelectrolytes and crosslinked polystyrene beads possessing trimethyl quarterly ammonium groups. Quaternary ammonium groups having at least one long fatty chain possess antimicrobial activity and are not typically released into the water when in use. This antimicrobial agent is suitable for deactivation biological contaminants by disrupting bacterial cell wall. Particles or other objects with high surface area possessing such quaternary ammonium provide a tool for deactivation of bacteria when passing through the filter. Examples of such polymers are alkyl quaternary poly(ethylene imine) and alkyl ammonium pyridine.

Quaternary ammonium poly(ethylene imine) (PEIo) was synthesized from the alkylation of crosslinked 100-200 micron beads of high molecular weight PEI (Mw=300,000) with octyl iodide (25% mole per total amino groups in the polymer or 1:1 with the primary amines) in toluene for 5 hours at reflux. After 5 hours, two equivalents of methyl iodide were reacted to form the quaternary ammonium. Hydrophilic versions of the alkylated beads were prepared by further alkylation of the beads with short chain poly(ethylene glycol) iodide or with similar hydrophilic residues such as hydroxyl-alkyl-iodide or bromide.

N-octyl-4-polyvinyl pyridinium iodide (PVPo) was synthesized from the reaction of commercially available 100-200 micron crosslinked PVP beads with octyl iodide (50% access over the pyridine groups) for 10 hours in toluene at reflux.

Activity of octyl polyethylene iminium iodide—Water solutions of bacteria were prepared by the addition of E. Coli stock to sterile water to achieve a bacteria level of 10³ CFU/25 ml. Control samples were prepared by incubation of 25 ml of this bacterial solution and filtering it through 0.45 μm pore size, 47 mm diameter sterile membrane using standard vacuum equipment. 25 ml of the solution were incubated with 1 g of PEIo in sterile plastic tube on rolling shaker at room temperature for 3, 10 and 20 min. For preparation of water samples after incubation, incubated samples were filtered through 0.45 μm pore size, 47 mm diameter sterile membrane using standard vacuum equipment. Membranes were placed on standard 50 mm 3.7% BHI-Agar plates and incubated for 20 hrs in 37° C. The plates were observed after incubation and E. coli colonies per 25 ml volume were counted.

Activity of 4-vinyl pyridinium octane—Water solutions of bacteria were prepared by the addition of E. Coli stock to sterile water to achieve a contamination level of 10⁷ CFU/25 ml. Four 25 ml samples of this bacterial solution was placed into 3 sterile plastic tubes containing 1 g 4-PVPo, 5 g 4-PVPo, 5 g PVP and one empty tube as control sample. Four test tubes were incubated on a shaker at room temperature for 24 hours. A 100-μl aliquot was taken from each test tube at 10, 30, 120, 240 min and 24 hours of incubation. 10-μl water aliquots were also taken and diluted by 10³ and 10⁵ fold with sterile DDW in order to permit counting of very dense samples. The bacterial solution before incubation, diluted and undiluted samples after incubation were spread on standard BHI-Agar plates and incubated overnight in 37° C. These plates were observed after incubation, E. coli colonies per 100 μl volume were counted and number of colonies per 1 ml was calculated in each sample.

Activity of trimethyl ammonium polystyrene based polymer loaded with iodine I₃⁻-AQ-44—Water solution of bacteria was prepared by the addition of E. Coli stock to sterile water to achieve a contamination level of 10⁷ CFUs/100 ml. Control samples before incubation were prepared from 100 μl of prepared E. coli solution spread on standard BHI-Agar plates. This solution was also diluted with sterile water by 10⁴ and 10⁵ fold in order to permit counting.

10 ml of undiluted bacterial solution was placed in a sterile plastic tube with 1 g of AQ-44, trimethyl ammonium polystyrene based polymer loaded with iodine ions (from Purolite) and incubated on shaker at room temperature. 100 μl and 10 μl samples of incubated bacterial solution were taken at 30 sec, 2.5, 4, 6.5, 10, 20 and 30 min of incubation. 100 μl samples were spread on standard BHI-Agar plates and 10 μl samples were diluted with sterile DDW by 10⁴ fold and 100 μl of these diluted samples were spread on standard BHI-Agar plates in order to permit counting of dense samples. The plates were incubated overnight in 37° C.

The plates were observed after incubation, E. coli colonies per 100 μl volume were counted and number of colonies per 1 ml was calculated in each sample.

The procedure was repeated with the same 1 g of polymer remained in the same tube six times after 90 min, 20 hrs, 30 hrs, 15 days and 20 days. During this time the polymer was washed with about of 10 liters of water. Incubation time was 30 sec and 5 min.

Testing of antibacterial polymer AQ-44—time incubation effect—AQ-44 was placed into 4 sterile glass containers, 20 g in each container and washed with 2 L of water. 5 L of bacterial solution containing E. Coli, Enterobater Aerogenus, Streptococcus Fecalis and Pseudomonas Aerogenosa were prepared by adding bacterial stock to sterile water. This bacterial solution was divided in 4 glass containers containing AQ-44, and incubated in each container for defined time: 2 min, 5 min, 10 min and 20 min at room temperature. The samples of incubated solution were taken for iodine determination using a UV spectrophotometer at 230 and 370 nm.

The solution was filtered immediately after incubation through filter A. The samples of incubated solution were taken for iodine determination by UV at 230 nm. As control, the experiment was repeated without using AQ-44 before filtration.

20 grams of AQ-44 polymer were placed into 4 sterile glass beakers. 5 L of bacterial solution containing Enterobater Aerogenus and Streptococcus Fecalis were prepared by adding bacterial stock to sterile water. 500 ml of this bacterial solution were placed in each of the 4 glass containers and held at room temperature for 10 seconds, 20 seconds, 30 seconds and 45 seconds.

The water samples after incubation were collected to the sterile plastic bottles containing 50 mg of sodium thiosulfate for neutralizing of residual iodine.

Collected water samples before and after incubation with AQ-44 and control sample were passed through a 0.45 μm pore size, 47 mm diameter sterile membrane using standard vacuum equipment. The membranes were placed on previously prepared standard 50 mm 3.7% BHI-Agar plates and incubated for 72 hrs in 37° C. The plates were observed after incubation and bacterial colonies per 100 ml were counted.

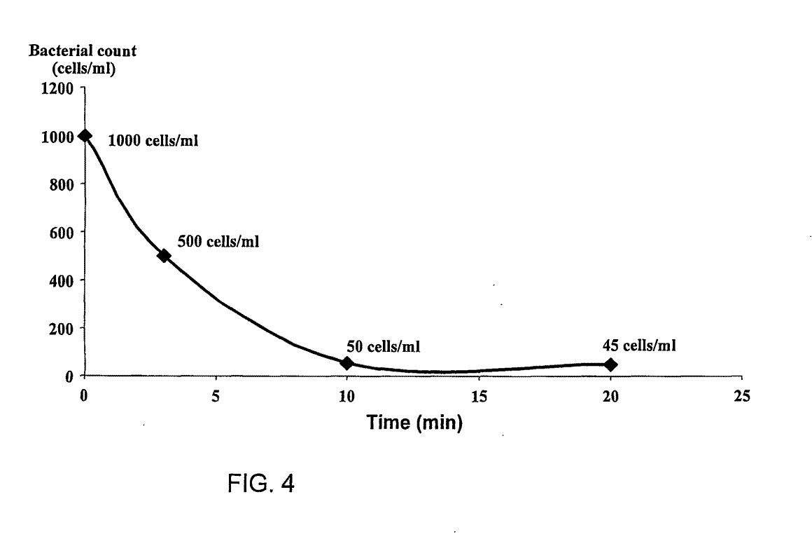

The results show that PEIo was efficient against E. Coli bacteria within 2 minutes of contact time. PEIo caused a 2-fold reduction after 3 minutes and 103 fold reduction in E. Coli contamination after 10 minutes of incubation (FIG. 4).

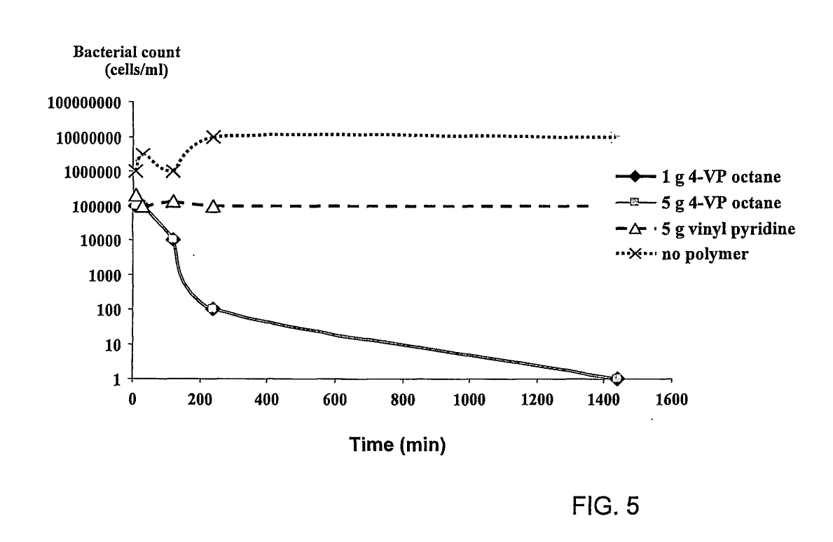

PVP-octane (4-VP-octane) caused total reduction of E. Coli contamination after 24 hours of incubation. 1 g and 5 g of PVP-octane caused total eradication of E. Coli bacteria after 24 hours incubation compared to no such effect observed with the control samples, i.e., no polymer and 5 g of unmodified vinyl pyridine (FIG. 5).

These studies show that polystyrene based polymer loaded with iodine ions marked as AQ-44 was effective against E. Coli bacteria within 30 seconds and caused more then three fold reduction in bacterial count. This antibacterial effect was continued also after repeated use of same polymer sample during 10 days and continued water washes. These results are summarized in Table 6.

TABLE 6
Continuous antibacterial effect of AQ-44 after 10 days and
10 liter water washes.

Bacterial count (cells/ml)

| Time (hrs) | After 30 sec incubation | After 5 min incubation |
|---|---|---|
| 0 | 1000000 | 1000000 |
| 0.5 | <10 | <10 |
| 1 | 260 | <10 |
| 1.5 | <10 | <10 |
| 2 | <10 | <10 |
| 20 | <10 | <10 |
| 26 | 2500 | <10 |
| 240 | <10 | <10 |

### Example 5

### Antibacterial Effect of Polystyrene-Based Polymer AQ-44

Antibacterial polymer AQ-44 was tested. Bacterial solutions containing E. Coli, Enterobater Aerogenus, Streptococcus Fecalis and Pseudomonas Aerogenosa were incubated with 20 g of AQ-44 for 20, 10, 5 and 2 minutes. These solutions were filtered through basic filter A and were spread on feeding plates. The plates were incubated in 37° C. overnight, and observed after incubation. Results of bacterial growth count after incubation with AQ-44 and following filtration obtained from Bactochem laboratories are summarized in Table 7.

TABLE 7
Growth count after incubation with AQ-44 and filtration

| | Time of | | | | |
|---|---|---|---|---|---|
| | incubation | Growth count after incubation with AQ-44 and filtration | | | |
| | with AQ-44 (min) | E. Coli | E. Aerogenus | Strep. Fecalis | P. Aerogenosa |
| Exp. | Before | CFU/100 ml | CFU/100 ml | CFU/100 ml | CFU/100 ml |
| No. | incubation | 40000000 | 30000000 | 10000000 | 30000000 |
| 1 | 20 | 0 | 0 | 0 | 0 |
| 2 | 10 | 0 | 0 | 0 | 0 |
| 3 | 5 | 0 | 0 | 0 | 0 |
| 4 | 2 | 0 | 0 | 0 | 0 |

The maximal antibacterial effect may be achieved after only 2 minutes of incubation with, following filtration. Total eradication of all bacteria types tested was achieved after 2 minutes of incubation with AQ-44 with following filtration.

Additional study was performed with shorter periods of incubation (10, 20, 30 and 45 seconds) without filtration. The bacterial solution contained Streptococcus Fecalis and Enterobater Aerogenus. The results of this study are summarized in Table 8.

TABLE 8
Effect of incubation time on antibacterial properties of AQ-44.

| Incubation time | Streptococcus Fecalis | Enterobacter Aerogenus |
|---|---|---|
| (sec) | (CFU/100 ml) | (CFU/100 ml) |
| 0 (before) | 10000000 | 11000000 |
| 10 | 64000 | 48 |
| 20 | 780 | 3 |
| 30 | 450 | 3 |
| 45 | 190 | 1 |

From Table 8 it may be observed that there is an increase in the antibacterial effect of AQ-44 within time on Streptococcus Fecalis and Enterobacter Aerogenus. Antibacterial effect on Enterobacter Aerogenus was at least by 2 logs stronger than on Streptococcus Fecalis.

### Example 6

### Determination of Iodine Release from Antibacterial Polymer AQ-44

Filters F and G were prepared by adding 10 g and 20 g of antibacterial polymer AQ-44, respectively to the basic integrated filter (filter A, see Example 1).

As the antibacterial polymer AQ-44 releases iodine, the determination of the degree of iodine release was required. Iodine solutions for standard curve preparation were prepared according to USP directions by dissolving 5 g iodine and 10 g potassium iodide in 10 ml of doubly distilled water (DDW), the volume was increased to 100 ml and diluted to an iodine concentration of 0.197 M or 50 mg/ml. This stock solution was used to prepare 7 sequentially concentration decreasing solutions of iodine. The starch solution was prepared by dissolving of 1 g rice starch in 200 ml of boiling water. The standard curve was prepared by measuring the color (using a spectrophotometer at 610 nm) of a solution containing 0.5 ml of the starch solution to 4.5 ml of the iodine solution. The samples of water incubated with AQ-44 or filtered through filters F or G containing AQ-44 were treated the same way as the standard iodine solution.

The iodine content was determined by the addition of 0.5 ml of the starch solution to 4.5 ml of the sample solution and measuring the resulting color by a spectrophotometer at 610 nm.

As Table 9 shows 20 g of AQ-44 released about 7.5 ppm of free iodine to the water during 20 minutes of incubation and about 4.5 ppm during 2-10 minutes of incubation. The iodine released was absorbed by the activated charcoal in the filter medium following filtration, thus giving an iodine concentration of the filtered water of less than the lower limit of determination (˜2.5 ppm).

TABLE 9
Iodine content in water incubated with AQ-44 before and
after filtration

| | | | Iodine |
|---|---|---|---|
| | | Iodine concentration | concentration |
| | Time of incubation | before filtration | after filtration |
| Experiment | with AQ-44 (min) | (ppm) | (ppm) |
| 1 | 20 | 7.27 | <2.5 |
| 2 | 10 | 4.53 | <2.5 |
| 3 | 5 | 4.42 | <2.5 |
| 4 | 2 | 4.51 | <2.5 |

### Example 7

### Release of Iodine from a Polyamide Fabric with Iodine

Preparation—Nylon fibers were soaked in 70 ml of a Lugol solution (5% iodine/potassium iodide solution in water) over night. The dark fabrics were washed with 100 ml DDW and dried out at room temperature for 5 hours. A short contact time system was used to evaluate the amount of iodine released to water at different periods of time. Samples were collected.

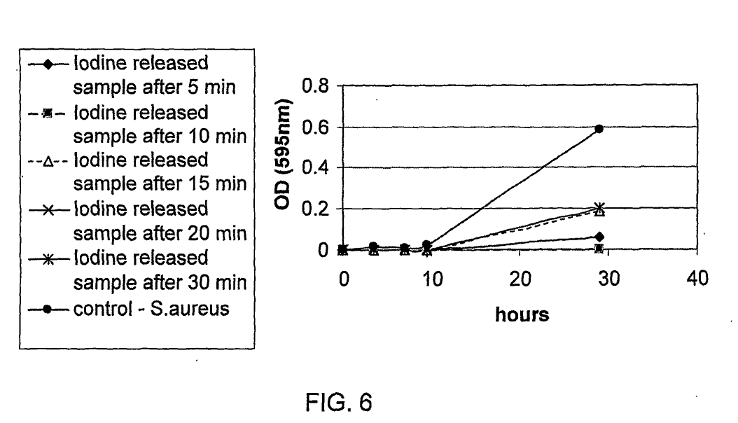

Determination of Antibacterial Activity—0.1 ml of Staphylococcus aureus were diluted in 3 ml TSB and incubated at 37° C. for about 24 hours. The optical density (OD) of the bacterial suspension was measured at 595 nm using an Elisa Reader ELX800 and three different concentrations of bacteria were prepared accordingly. Next, a microtiter plate (96-wells flat bottom plate) was filled with 200 microliter from each iodine sample and 50 microliter bacteria at three different concentrations and incubated at 37° C. During the incubation period bacterial outgrowth was estimated by changes in the OD measured every several hours. All experiments were performed in triplicate and the mean values were calculated. As FIG. 6 shows the OD of the bacterial suspension was clearly lowered upon addition of the iodine solution which means that the growth of S. aureus was inhibited. Also it can be seen that the activity was not reduced as function of time, since samples taken at different times showed no meaningful change in activity.

### Example 8

### Antimicrobial Effect of Iodine Complexed Nylon Screens

The efficiency of the iodinated nylon fabrics in killing bacteria was also tested at large influent volumes, e.g., 500 liters of water. Apart from the microbiological effect, iodine release to water and water filtration time were monitored as well.

Materials—Nylon 6,6 or Nylon 6 screens (NITEX fabrics 06, Sefar, Switzerland), E. Coli, Stafilococus aureus (STA), 47 mm diameter sterilized membranes having 0.45 μm pore size, sterilized vacuum filtration equipment (MilliPore), 5 cm diameter differential growth plates for coliforms (E. coli)—M-Endo Agar LES and for STA—Baired Parker (HyLabs).

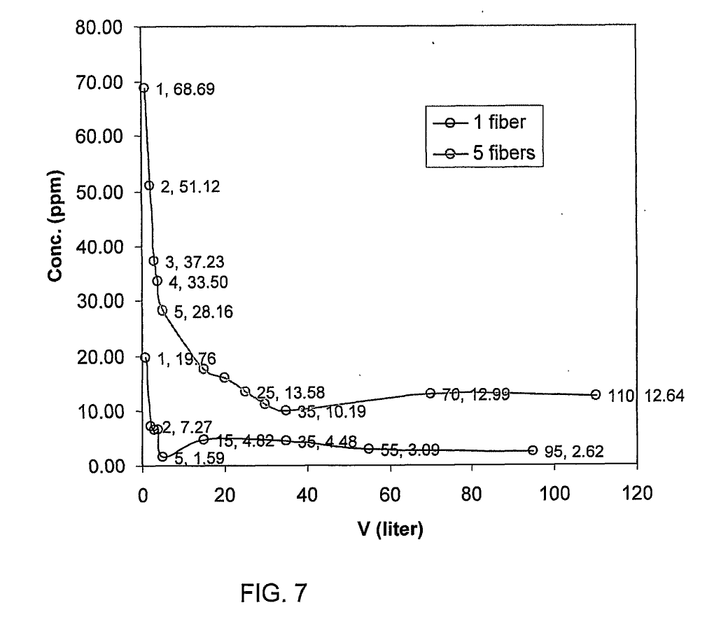

Filter contents—10 g of iodinated NITEX fabrics loaded with 50% w/w iodine were placed in a filter of drinking bottle (in the water sleeve) and the whole bottle was placed under a water tap. The iodinated screens were prepared by placing the screens in a 5% w/v iodine/KI solution for a few hours. After drying at room air the iodine loading was 50% of the screen. The release of iodine to the water was determined by UV absorption at 230 nm. The iodine concentrations after filtration of 100 to 500 liters of water are shown in FIG. 7. As can be seen, after an initial burst of iodine, constant active levels of iodine concentration in water were found. This amount of iodine may last for more than 500 liters where the experiment was terminated.

Water solution of bacteria preparation—Calibration test for bacteria concentration was performed. A diluted solution of both Stafilococus aureus (STA) and E. coli growth solutions were made as follows:

A 1/5 calibration solution contained 0.25 ml incubated bacteria solution in 1 ml growth medium. Bacterial suspension optical density (OD) was measured at 595 nm using a Universal Microplate Reader-ELX800. The 96-wells flat bottom plate was filled with 200 μl of the bacteria solution. Duplicates from each 1/5 solution for each bacteria were measured and the mean values were calculated. According to OD results bacteria concentrations were prepared. The 1/5 calibration solution for STA and 1/5 calibration solution for E. coli showed OD of 0.22±0.05. According to prior experiments the concentration of STA in the original growth solution was 2.9*10⁹ bacteria/ml and the concentration of E. coli in the original growth solution was 1.6*10⁹ bacteria/ml. To achieve a concentration of 10⁷ bacteria/100 ml of water 1/40 dilution for each bacteria were prepared. 0.2 ml of the original growth bacteria solution of each bacteria were diluted in 7.8 ml of sterilized water. 1 ml from each of the 1/40 solution of bacteria, a total of 2 ml, were diluted in 500 ml sterilized water. In order to count the number of colonies per 100 ml bacteria solution before iodine filtration, the bacteria solution (of 10⁷CFU/500 ml) was diluted in two different bottles to 100 CFU/100 ml and 10 CFU/100 ml.

Iodine fabrics Filtration—Before filtration of each of the bacteria solution 100 ml of sterile water was filtrated through the fabric and iodine concentration in water was measured by a spectrophotometric method at 610 nm, which involved absorption of iodine and complexetion with starch (sensitivity 5-20 ppm). 100 ml of 10⁷/500 ml bacteria solution were filtered through each of the two filters. The filtrates were collected to sterile bottles. Filtrates were also diluted in 10⁻² and 10⁻⁴ in 2 in order to be able to count bacteria colonies in case of inefficiency. Flow time of each 100 ml solution filtration was measured.

Seeding—All solutions (100 ml each) were passed through a 0.45 μm pore size sterilized membrane using Millipore sterilized vacuum equipment. 100 ml of sterilized water were filtered at first for control and then the order off filtration was from the most bacteria diluted to the most polluted. Each sample was filtered twice (100 ml each time) in order to be seeded both on LES and Baird Parker plates for differential growth of the two pathogens. After filtration the membrane was placed. on the plate. Plates were incubated for 20 hrs in 27° C. After incubation period bacteria colonies per 100 ml were counted.

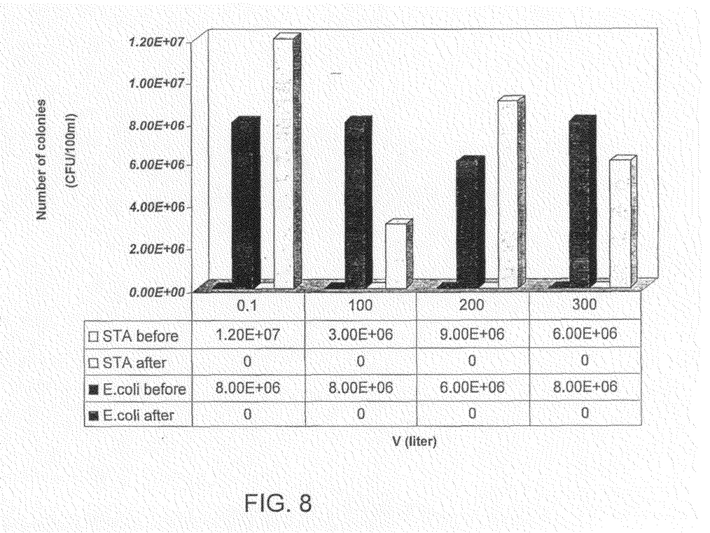

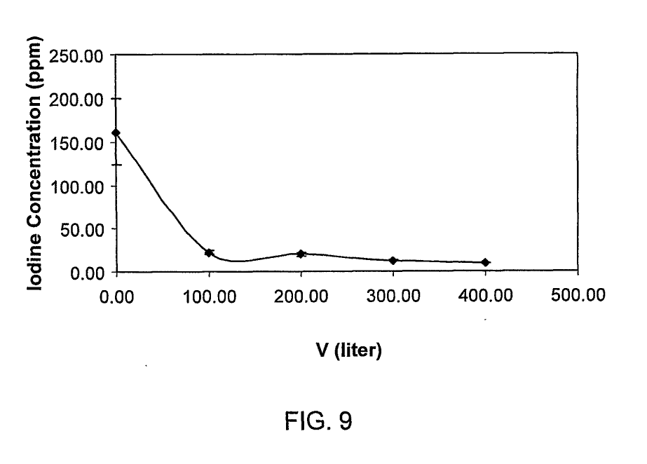

Water filtration—The purpose of this study was to test the efficiency of the iodinated fabric after hundreds of liter of water. After each seeding, 100 L of water were filtrated. The bottles were placed under a tap of flowing water at a rate of 1 liter/30 sec. Tables 10 and 11 and FIGS. 8 and 9 present the results.

TABLE 10
Zero time- number of colonies before
water filtration with iodine fabrics

| | | | STA | | E-coli | |
|---|---|---|---|---|---|---|
| | | | (CFU/100 ml) | | (CFU/100 ml) | |
| V | Sterile | | Dilution | Dilution | Dilution | Dilution |
| (liter) | water | before | of ×10⁵ | of ×10⁶ | of ×10⁵ | of ×10⁶ |
| 0.1 | 0 | ~10⁷ | 101 | 12 | 91 | 8 |
| 100 | 0 | ~10⁷ | 41 | 3 | 38 | 8 |
| 200 | 0 | ~10⁷ | 72 | 9 | 45 | 6 |
| 300 | 0 | ~10⁷ | 68 | 6 | 75 | 8 |
| 400 | 0 | ~10⁷ | | | | |
| 500 | | ~10⁷ | | | | |

TABLE 11
Number of colonies after filtration with iodine fabrics

| | | Iodine | | |
|---|---|---|---|---|
| | Water flow | concentration | STA | E-coli |
| V (liters) | (min/liter) | (ppm) | CFU/100 ml | CFU/100 ml |
| 0.1 | 1:15 ± 0:21 | 162.08 ± 38.27 | 0 | 0 |
| 100 | 1:06 ± 0:36 | 22.71 ± 1.81 | 0 | 0 |
| 200 | 1:25 ± 0:49 | 20.60 ± 2.02 | 0 | 0 |
| 300 | 0:53 ± 0:00 | 12.71 ± 0.47 | 0 | 0 |
| 400 | 0:30 ± 0:00 | 9.20 ± 0.16 | 0 | 0 |
| 500 | 0.30 ± 0:00 | 8.0 ± 0.50 | 0 | 0 |

### Example 9

### Capturing of Iodine Vapors from Iodine-Complexed Fabric or Polymer Beads

When loading the iodine-complexed polymer systems into the filter chamber containing the filter medium of the invention, it was found that over time iodine vapors released from the polymer complex reached the upper part of the chamber and stained the filter holders. Although the amount of iodine released as vapors was negligible with respect to the active iodine available to decontaminate bacteria, the staining presented an esthetic disadvantage. To avoid the effect of iodine vapors, the following strategies were applied.

1. Placing an iodine-scavenging agent on top of the iodine polymer complex either in bead form or fabric that was capable of collecting the iodine vapors that were gradually released from the polymer complex. In this approach, granules of active carbon, crosslinked poly(vinylpyrrolidone) beads, trimethyl ammonium derivatives of amino methyl polystyrene, or polyamide fabric and beads were placed on top of the iodine complex at a 1:1, 1:3, 1:5 and 1:10 w/w ratio to the iodine-polymer complex and the iodine vapors were visualized after 10 days at room temperature. The experiment was conducted as follows: in polypropylene plastic tubes samples of polyamide fabric loaded with 50% iodine, as described above, was placed at the bottom of the tube. On top of the fabric, the scavenging agents were evenly placed. On top of the sample, a polyamide fabric was hanged with the intention that it will collect the evaporated iodine for analysis. The tubes were kept at room temperature for 10 days and the color of the tube and the fabric was monitored, where a yellow color indicated free iodine release. After 10 days the samples were disassembled and iodine content in the scavenging agent and the fabric was determined. As control, a tube without the iodine complex and a tube with only iodine-polymer complex were used.

The tubes containing carbon at any ratio remained completely clear similarly to the control without iodine. The tubes loaded with polyvinylpyrrolidone beads and polystyrene beads were also effective but only at a ratio of 1:5 and higher.

2. The second approach that was taken involved the coating of the top layer of the iodine-polymer complex beads or fabric with a polymer coating for entraping the iodine within the coating under dry conditions and release iodine when wetted. Such coatings were hydrogels made from poly(hydroxyethylmethacrylate-co-methyl methacrylate) 4:1, poly(methacrylic acid-co-methyl methacrylate) 1:2, hydroxypropyl methyl cellulose and blends with ethyl cellulose. The coating was applied by either dipping in the coating polymer solution in dichloromethane or ethanol or spraying the polymer solution onto the iodine polymer. These coatings affected the release rate of iodine from the polymer-iodine complex and reduced the iodine evaporation.

The amount of iodine collected in the scavenging substrates as detected by titration with thiosulfates in all experiments was less than 2% of the total iodine in the complex.

3. Mechanical means were also included where the top part of the filter was shielded and opened only when water was placed onto the filter. Such shield can be fully mechanical or combination of a hydrogel membrane that opens and swells in the presence of water.

### Example 10

### Efficiency of Lead and Cadmium Removal by Filters Containing a Filter Medium of the Invention

Filters comprising a filter medium according to the present invention were prepared and tested for the ability to remove heavy metals such as lead and cadmium from water. The filters tested in this experiment contained:

Carbonaceous material—70 g Carbon 12×30 impregnated with 0.05% Ag,

Metal oxide or hydroxide—30 g iron oxide nanoparticles embedded in polystyrene beads,

Ion exchanger—15 g macroporous polystyrene based chelating resin beads, with iminodiacetic groups designed for the removal of cations of heavy metals from water effluents with specific affinity to cadmium ions and other metal ions, and 15 g polystyrene beads with sulfate acid and potassium sulfate functionalities with general affinity to heavy metals.

In this experiment, the filter medium contained no chitosan.

The tested metal ions were cadmium (II) and lead (II).

Layers of the medium materials mentioned above were placed vertically in the following order from top to bottom in the direction of the water flow:
15 g polystyrene beads with sulfate acid and potassium sulfate functionalities;
20 g Carbon 12×30 impregnated with 0.05% Ag;
15 g polystyrene beads with iminodiacetic functional groups;
50 g Carbon 12×30 impregnated with 0.05% Ag; and at the bottom,
30 g iron oxide nanoparticles embedded in polystyrene beads.

At the beginning of the experiments, all such constructed filters were washed with 10 L tap water. 100 L of metal solution that contained Pb ions (in the form of aqueous lead (II) nitrate) and Cd ions (in the form of aqueous cadmium chloride) with NSF [the US & international non-profit organization for standards for water purification devices, www.nsf.org] influent challenge concentrations at 20±2.5° C. and at PH=6.5±0.25 were transferred through the filters and samples were collected at 0 L, 25 L, 50 L and 100 L. 12-24 hours brakes were made in solution passage through filters A and B after 25 L, 75 L, 125 L, 150 L 200 L and 250 L. For column C those brakes were made after 50 L, 100 L, 150 L, 200 L and 250 L. The collected samples were measured for Pb and Cd concentration at ICP.

TABLE 12
pH, TDS and turbidity measurements following NSF influent challenge concentrations
of Cd and Pb ions at varying solution volumes, flowrate and temperatures.

| | | Flow | | | | TDS | | Turbidity | |
|---|---|---|---|---|---|---|---|---|---|
| | | rate | Temp | pH | | (ppm) | | (NTU) | |
| Filter | Liters | (min/L) | (° C.) | Before | After | Before | After | Before | After |
| A | 0 | 4 | 22 | 6.7 | 7.15 | 761 | 745 | 0.16 | 0.07 |
| B | 0 | 4 | 22 | | 7.02 | 761 | 739 | 0.16 | 0.08 |
| C | 0 | 5.56 | 22 | 6.6 | 7 | 721 | 735 | 0.16 | 0.3 |
| A | 5 | 5.7 | 22 | | 7.15 | 761 | 745 | 0.16 | 0.08 |
| B | 5 | 6 | 22 | | 7.02 | 761 | 747 | 0.16 | 0.07 |
| A | 25 | 6.7 | 22 | | 7 | 759 | 732 | 0.12 | 0.06 |
| B | 25 | 6 | 22 | | 6.9 | 759 | 736 | 0.12 | 0.07 |
| C | 25 | 6.1 | 22 | 6.6 | 7 | 767 | 756 | 0.12 | 0.09 |
| A | 30 | 7.5 | 19 | 6.7 | 7 | 722 | 715 | 0.09 | 0.09 |
| B | 30 | 6 | 19 | | 7 | 722 | 707 | 0.09 | 0.07 |
| A | 50 | 7.2 | 19 | 6.7 | 7 | 722 | 749 | 0.09 | 0.12 |
| B | 50 | 5.6 | 19 | 6.7 | 7 | 722 | 749 | 0.09 | 0.06 |
| C | 50 | 6.4 | 19 | 6.7 | 6.83 | 710 | 748 | 0.08 | 0.09 |
| C | 55 | 5.6 | 19 | 6.7 | 6.85 | 716 | 695 | 0.14 | 0.08 |
| A | 75 | 7.8 | 19 | 6.6 | 7 | 755 | 764 | 0.12 | 0.09 |
| B | 75 | 6 | 19 | | 7 | 755 | 751 | 0.12 | 0.07 |
| C | 75 | 5 | 20 | | 6.7 | 765 | 760 | 0.1 | 0.1 |
| A | 80 | 7.2 | 19 | | 7.3 | 710 | 702 | 0.09 | 0.11 |
| B | 80 | 6.1 | 19 | | 7.3 | 710 | 700 | 0.09 | 0.09 |
| A | 100 | 6.7 | 20 | 6.6 | 7 | 760 | 760 | 0.09 | 0.09 |
| B | 100 | 5.8 | 20 | | 7 | 760 | 753 | 0.09 | 0.07 |
| C | 100 | 6.7 | 22 | 6.5 | 6.9 | 705 | 760 | 0.21 | 0.09 |
| C | 105 | 7.2 | 18 | 6.7 | 7 | 734 | 767 | 0.2 | 0.2 |
| A | 125 | 7.8 | 20 | 6.6 | 7 | 773 | 756 | 0.12 | 0.19 |
| B | 125 | 6.11 | 20 | 6.6 | 7 | 773 | 768 | 0.12 | 0.17 |
| C | 125 | 7.2 | 20 | 6.7 | 6.9 | 730 | 734 | 0.2 | 0.1 |
| A | 130 | 6.7 | 21 | 6.7 | 7 | 764 | 752 | 0.19 | 0.09 |
| B | 130 | 5.75 | 21 | 6.7 | 6.95 | 764 | 752 | 0.19 | 0.14 |
| A | 150 | 6.1 | 20 | 6.7 | 6.84 | 753 | 764 | 0.14 | 0.08 |
| B | 150 | 5 | 20 | 6.7 | 6.86 | 753 | 755 | 0.14 | 0.13 |
| C | 150 | 7.2 | 21 | 6.7 | 6.9 | 729 | 747 | 0.2 | 0.2 |
| B | 155 | 5.8 | 22 | 6.6 | 7 | 721 | 762 | 0.16 | 0.16 |
| C | 155 | 7.8 | 18 | 6.64 | 6.93 | 713 | 728 | 0.1 | 0.1 |
| B | 175 | 6 | 22 | 6.6 | 7 | 767 | 757 | 0.12 | 0.09 |
| C | 175 | 6.3 | 16.5 | 6.6 | 6.7 | 712 | 715 | 0.2 | 0.2 |
| B | 200 | 5.55 | 19 | 6.7 | 6.85 | 710 | 743 | 0.08 | 0.08 |
| C | 200 | 5.5 | 16 | 6.63 | 6.77 | 703 | 715 | 0.3 | 0.2 |
| B | 205 | 6.4 | 19 | 6.7 | 7 | 716 | 712 | 0.14 | 0.11 |
| C | 205 | 7.4 | 14 | 6.68 | 6.9 | 715 | 678 | 0.2 | 0.1 |
| B | 225 | 5 | 20 | 6.5 | 6.5 | 765 | 765 | 0.1 | 0.1 |
| C | 225 | 5.4 | 17 | 6.65 | 6.8 | 710 | 699 | 0.3 | 0.3 |
| B | 250 | 7.8 | 22 | 6.5 | 7 | 705 | 750 | 0.21 | 0.15 |
| C | 250 | 7.2 | 17 | 6.65 | 6.8 | 717 | 725 | 0.3 | 0.1 |
| B | 255 | 8.6 | 18 | 6.7 | 7.1 | 754 | 739. | 0.2 | 0.1 |
| C | 255 | 7.2 | 17 | 6.7 | 7.2 | 697 | 693 | 0.1 | 0.1 |
| B | 275 | 7.2 | 20 | 6.7 | 6.9 | 730 | 729 | 0.2 | 0.1 |
| C | 275 | 6.1 | 19 | 6.7 | 6.9 | 761 | 769 | 0.1 | 0.1 |
| B | 300 | 7.8 | 21 | 6.7 | 6.8 | 729 | 766 | 0.2 | 0.1 |
| C | 300 | 7.8 | 19 | 6.7 | 6.85 | 780 | 794 | 0.1 | 0.1 |

TABLE 13
Efficiency in removing Cd and Pb ions in
filters with layered active materials

| | | Pb | | | Cd | | |
|---|---|---|---|---|---|---|---|
| column | L | Before | After | % | Before | After | % |
| A | 0 | 0.1755 | <0.006 | 97 | 0.0328 | <0.0005 | 98 |
| B | 0 | | <0.006 | 97 | | <0.0005 | 98 |
| C | 0 | 0.1487 | <0.006 | 96 | 0.0293 | <0.0005 | 98 |
| A | 5 | 0.1755 | <0.006 | 97 | 0.0328 | <0.0005 | 98 |
| B | 5 | | <0.006 | 97 | | <0.0005 | 98 |
| A | 25 | 0.1836 | <0.006 | 97 | 0.0341 | 0.0013 | 95 |
| B | 25 | | <0.006 | 97 | | 0.0016 | 95 |
| C | 25 | 0.1584 | <0.006 | 96 | 0.0304 | 0.00076 | 97 |
| A | 30 | 0.1647 | <0.006 | 97 | 0.0298 | <0.0005 | 98 |
| B | 30 | | <0.006 | 97 | | <0.0005 | 98 |
| A | 50 | 0.1647 | <0.006 | 97 | 0.0298 | 0.0017 | 95 |
| B | 50 | | <0.006 | 97 | | 0.0027 | 91 |
| C | 50 | 0.1581 | <0.006 | 97 | 0.0305 | 0.002 | 93 |
| C | 55 | 0.154 | <0.006 | 96 | 0.297 | <0.0005 | 98 |
| A | 75 | 0.1685 | <0.006 | 97 | 0.0307 | 0.0025 | 92 |
| B | 75 | | <0.006 | 97 | | 0.0036 | 88 |
| C | 75 | 0.159 | <0.006 | 96 | 0.03 | 0.00385 | 87 |
| A | 80 | 0.166 | <0.006 | 97 | 0.031 | 0.0014 | 95 |
| B | 80 | | <0.006 | 97 | | 0.0019 | 94 |
| A | 100 | 0.165 | <0.006 | 97 | 0.031 | 0.0031 | 90 |
| B | 100 | | <0.006 | 97 | | 0.0042 | 86 |
| C | 100 | 0.157 | <0.006 | 96 | 0.03 | 0.0026 | 91 |
| C | 105 | 0.1696 | <0.006 | 96 | 0.0314 | 0.0012 | 96 |
| A | 125 | 0.163 | <0.006 | 97 | 0.031 | 0.0035 | 89 |
| B | 125 | | <0.006 | 97 | 0.031 | 0.0051 | 84 |
| C | 125 | 0.168 | <0.006 | 96 | 0.0316 | 0.0037 | 89 |
| A | 130 | 0.1562 | <0.006 | 96 | 0.03 | 0.0017 | 94 |
| B | 130 | | <0.006 | 96 | 0.03 | 0.0037 | 88 |
| A | 150 | 0.158 | <0.006 | 96 | 0.0302 | 0.0028 | 90 |
| B | 150 | | <0.006 | 96 | 0.0302 | 0.0037 | 88 |
| C | 150 | 0.168 | <0.006 | 96 | 0.0316 | 0.0051 | 94 |
| B | 155 | 0.1487 | <0.006 | 96 | 0.0293 | 0.0021 | 93 |
| B | 175 | 0.1584 | <0.006 | 96 | 0.0304 | 0.0031 | 90 |
| B | 200 | 0.1581 | <0.006 | 96 | 0.0305 | 0.0061 | 80 |
| B | 205 | 0.154 | <0.006 | 96 | 0.0297 | 0.0027 | 91 |
| C | 205 | 0.1553 | <0.006 | 96 | 0.029 | 0.0039 | 86 |
| B | 225 | 0.159 | <0.006 | 96 | 0.03 | 0.0071 | 76 |
| C | 225 | 0.157 | <0.006 | 96 | 0.029 | 0.0081 | 73 |
| B | 250 | 0.157 | <0.006 | 96 | 0.03 | 0.005 | 84 |
| C | 250 | 0.1575 | <0.006 | 96 | 0.0289 | 0.0097 | 66 |
| B | 255 | 0.1696 | <0.006 | 96 | 0.0314 | 0.004 | 88 |
| C | 255 | 0.13 | <0.006 | 95 | 0.025 | 0.0033 | 87 |
| B | 275 | 0.168 | <0.006 | 96 | 0.032 | 0.0061 | 81 |
| C | 275 | 0.13 | <0.006 | 95 | 0.025 | 0.0057 | 77 |
| B | 300 | 0.168 | <0.006 | 96 | 0.0316 | 0.0076 | 75 |
| C | 300 | 0.13 | <0.006 | 95 | 0.025 | 0.0064 | 75 |
| NSF | | 0.15 | 0.01 | 94 | 0.03 | 0.005 | 84 |

As may be noted from Tables 12 and 13, filters with layered active materials were more efficient in removing Cd ions in accordance with NSF requirements. Filters removed Cd significantly better after the 12-36 h brake. In samples from 130 L, 155 L, 205 L and 255 L that were taken after the brake, the Cd concentration was 0.001-0.003 ppm lower than the samples from 125 L, 150 L, 200 L and 250 L that were taken after 50 L of continuous cadmium solution passage through the filters. Columns with layered active materials succeeded also in removing Pb ions in accordance with NSF requirements.

### Example 11

### Efficiency of Cadmium Removal by Filters Containing a Medium According to the Invention

In this experiment, a filter was constructed with the same medium materials used in Example 10 above. Layers of the medium materials were placed vertically in the following order from top to bottom in the direction of the water flow:
20 g Carbon 12×30 impregnated with 0.05% Ag;
15 g polystyrene beads with iminodiacetic functional groups;
50 g Carbon 12×30 impregnated with 0.05% Ag; and at the bottom,
30 g iron oxide nanoparticles embedded in polystyrene beads.

At the beginning of the experiments, all such constructed filters were washed with 10 L tap water. 100 L of metal solution that contained Pb ions (in the form of aqueous lead (II) nitrate) and Cd ions (in the form of aqueous cadmium chloride) with NSF influent challenge concentrations at 20±2.5° C. and at PH=6.5±0.25 were transferred through the filters and samples were collected at 0 L, 25 L, 50 L and 100 L. 12-24 hours brakes were made in solution passage through filters A and B after 50 L and 100 L. The collected samples were measured for Pb and Cd concentration at ICP.

TABLE 14
pH, TDS and turbidity measurements following NSF influent challenge concentrations
of Cd and Pb ions at varying solution volumes, flowrate and temperature.

| | | Flow | | | | TDS | | Turbidity | |
|---|---|---|---|---|---|---|---|---|---|
| | | rate | Temp | pH | | (ppm) | | (NTU) | |
| Filter | Liters | (min/L) | (° C.) | Before | After | Before | After | Before | After |
| A | 0 | 5.55 | 20 | 6.5 | 7 | 24 | 45 | 0.33 | 0.46 |
| B | 0 | 5.55 | 20 | | 7 | 24 | 39 | 0.33 | 0.18 |
| A | 25 | 5.55 | 20 | | 6.7 | 44 | 25 | 0.42 | 0.43 |
| B | 25 | 5.55 | 20 | | 6.6 | 44 | 28 | 0.42 | 0.23 |
| A | 50 | 5.3 | 20 | 6.45 | 6.4 | 25 | 27 | 0.35 | 0.5 |
| B | 50 | 5.3 | 20 | | 6.4 | 25 | 21 | 0.35 | 0.13 |
| A | 55 | 6 | 20 | 6.6 | 6.6 | 25 | 35 | 0.28 | 0.1 |
| B | 55 | 6 | 20 | | 6.6 | 25 | 30 | 0.28 | 0.1 |
| A | 75 | 4.7 | 20 | 6.6 | 6.7 | 20 | 22 | 0.13 | 0.15 |
| B | 75 | 5 | 20 | | 6.7 | 20 | 22 | 0.13 | 0.14 |
| A | 100 | 7.2 | 20 | 6.6 | 6.7 | 22 | 26 | 0.12 | 0.08 |
| B | 100 | 6.1 | 20 | | 6.5 | 22 | 22 | 0.12 | 0.08 |
| A | 105 | 7.8 | 16 | 6.6 | 6.9 | 23 | 29 | 0.24 | 0.2 |
| B | 105 | 7.2 | 16 | 6.6 | 6.8 | 23 | 34 | 0.24 | 0.09 |
| A | 125 | 7.8 | 17.5 | 6.6 | 6.65 | 28 | 36 | 0.28 | 0.14 |
| B | 125 | 6.1 | 17.5 | | 6.65 | 28 | 28 | 0.28 | 0.14 |
| A | 150 | 7.5 | 17.5 | | 6.84 | 24 | 27 | 0.18 | 0.15 |
| B | 150 | 6.1 | 17.5 | | 6.66 | 24 | 23 | 0.18 | 0.09 |

TABLE 15
Efficiency in removing Cd ions in varying solution volumes

| | | Cd | | |
|---|---|---|---|---|
| column | L | Before | After | % |
| A | 0 | 0.0311 | <0.0005 | |
| B | 0 | | <0.0005 | |
| A | 25 | 0.0306 | <0.0005 | |
| B | 25 | | <0.0005 | |
| A | 50 | 0.0314 | 0.0009 | |
| B | 50 | | 0.0009 | |
| A | 55 | 0.0314 | 0.0009 | |
| B | 55 | | 0.0010 | |
| A | 75 | 0.0314 | 0.0026 | |
| B | 75 | | 0.0027 | |
| A | 100 | 0.0316 | 0.0028 | |
| B | 100 | | 0.0026 | |
| A | | | | |
| NSF | | 0.03 | 0.005 | |

As may be noted from Tables 14 and 15, filters with the layered active materials were efficient in removing Cd ions in accordance with NSF requirements.

### Example 12

### Efficiency of Bacteria Removal by Filters Comprising the Medium According to the Invention

Filters employing a medium according to the invention were mounted with an iodine polyurethane sponge and the ability to remove bacteria existing in the water was tested.

Water Suspension of Bacteria Preparation:

Calibration test for bacteria concentration was performed. For that test, a diluted suspension of E. coli was prepared as follows: 1/5 calibration suspension-0.25 ml bacteria growth suspension in 1 ml growth medium. The optical density (OD) of the bacterial suspensions were measured at 595 nm using a Universal Microplate Reader—ELX800. According to prior experiments, an OD of 0.22 corresponds to 2×10⁹ bacteria/ml. To achieve a concentration of 10⁷ bacteria per 3000 ml of water, a diluted suspension of E. coli growth suspension were prepared as followed: 1/40 suspension-0.2 ml bacteria growth suspension in 7.8 ml of mineral water. 1 ml 1/40 of each bacteria suspension, total of 2 ml, was diluted in 500 ml mineral water. In order to count the number of colonies forming unites (CFU's) per 100 ml before filtration, dilutions of contaminated water to 100 CFU's per 100 ml of water and 10 CFU's per 100 ml of water were prepared.

Iodine Polyurethane Sponge Filtration:

3000 ml of contaminated water were filtered through the filter containing a medium of the invention. The experiment was repeated with three filters. The filtrates were collected to sterile bottles. Filtrates were also diluted to 10⁻² and 10⁻⁴ in order to enable to count CFU's in case of inefficiency of filters in killing all bacteria. Flow time of each 3000 ml filtration was measured.

Seeding:

All the samples were passed through a 0.45 μm pore size sterilized cellulose membrane using Millipore sterilized vacuum equipment. 3000 ml of mineral water were filtered at first for control of the water used and then the order of filtration was from the most bacteria diluted to the most polluted. After filtration the membrane was placed on the plate. Plates were incubated for 20 hours at 37° C. After the incubation period CFU's per 3000 ml were counted.

The antibacterial activity was estimated against E. coli strain MG1655 following the same procedure as described above with only one sampling of each filter. First, 10 L of tap water were transferred and a sample of tap water through the tested filter was collected for contamination control, then 3 L of contaminated water were transferred and a sample was collected after 1 L transferred trough the filter and finally 10 L of tap water were transferred. Growth plates purchased from HyLabs—For E. coli M-ENDO AGAR LES, type LD506, lot 9680 was used. The experiment was performed in duplicates.

Iodinated Polyurethane (PU) Sponge Preparation:

Lugol solution was made by dissolving 5 gr iodine and 10 gr of potassium iodide in 100 ml doubly distilled water (DDW). The I₂/KI ratio was kept at 1:2 and I₂ concentration at 50×10³ mg/L.

PU sponge were maintained in a lugol solution according to the fabrics/sponge amount (all the fabrics/sponge were covered up with lugol), with shaking overnight. Next, the sponges were taken out for drying in a ventilation hood for a period of one day.

PU sponge with ethylene vinyl acetae (EVA) coating was prepared by spraying of EVA based coating solution on both sides of the sponge. The sponges were taken out for drying in a ventilation hood for a period of one day.

EVA Solutions Preparations:

Solution 5% EVA in chloroform was prepared by dissolving 15.6 g EVA in 200 ml chloroform.

I. Antimicrobial Test with Polyurethane Sponge.

The efficiency of filters containing iodinated polyurethane (PU) sponge, crosslinked chitosan, activated carbon impregnated with 1.05% silver and ion exchanger resins, as exemplified in Examples 10-11, in killing bacteria was tested with filters after filtration of 200 L tap water.

A. Polyurethane A—sponge loaded with 50% w/w iodine and coated with EVA (4 dippings to form a thin coating)—partial growth of STA and E. Coli was observed. About 100 STA bacteria/100 ml grew after filtration. This suggests that the filter lowered STA concentration in water by 5 folds. Only 1 E. coli bacteria/100 ml grew after filtration, suggesting a 7-fold decrease in the growth of E. coli.

B. Polyurethane B sponge loaded with 50% w/w iodine and coated with EVA (8 dippings to form a thicker coating which provides a longer release period or more water passing)—partial growth of STA and E. coli was observed. Only 1 STA bacteria/100 ml grew after filtration, suggesting a 7-fold decrease in STA concentration. A similar decrease was observed with E. coli.

### II. Absorption and Release of Iodine

1. Iodine adsorption and % EVA coating:

TABLE 16
Iodine adsorption and % EVA coating

| | | Iodine | | weight | |
|---|---|---|---|---|---|
| Filter | | weight | % Iodine | EVA | EVA |
| No. | Sponge | (g) | (% w/w) | (g) | (% w/w) |
| 1 | 107-1 | 4.05 | 59.30 | 1.22 | 13.46 |
| 2 | 107-2 | 4.27 | 60.37 | 1.17 | 12.64 |
| 3 | 107-3 | 4.00 | 59.18 | 1.25 | 13.87 |
| 4 | 107-4 | 4.07 | 59.14 | 1.23 | 13.49 |

2. Iodine release from the lower tank (ppm) in filters 1/2/3:

TABLE 17
Iodine release from the lower tank (ppm) in filters 1/2/3.

| | | | Average | |
|---|---|---|---|---|
| | Filter 3 | Filter 4 | filters | S.D. |
| 0 | 4.2 | 7 | 5.60 | 1.98 |
| 10 | 7 | 8.3 | 7.65 | 0.92 |
| 25 | 9.1 | 9.2 | 9.15 | 0.07 |
| 50 | 9.4 | 9.4 | 9.40 | 0.00 |
| 60 | 8.5 | 8.2 | 8.35 | 0.21 |
| 80 | 8.1 | 8 | 8.05 | 0.07 |
| 100 | 8.3 | 8.2 | 8.25 | 0.07 |
| 110 | 8.2 | 8.5 | 8.35 | 0.21 |
| 125 | 8.1 | 7.7 | 7.90 | 0.28 |
| 150 | 7 | 7.8 | 7.40 | 0.57 |
| 160 | 6.9 | 7.5 | 7.20 | 0.42 |
| 180 | 7.7 | 8 | 7.85 | 0.21 |

3. Antibacterial result.

TABLE 18
Bacterial concentration (CFU/100 ml) after filtration of 100 L at
various flow rates.

| | flow rate | Water | Bacterial concentration |
|---|---|---|---|
| Filter | (min/L) | filtration | (CFU/100 ml) |
| 1 | 15 | 100 L | <1 |
| 2 | 14.5 | 100 L | 3 |
| 7 | 6 | 100 L | 2 |
| 8 | 6.5 | 100 L | 3 |

In summary, after filtration of 100 L:
Filter 1 reduces E. coli concentration in water by 7 folds.
Filters 2, 7 and 8 reduced E. coli concentration in water by 6-7 folds.

1.-53. (canceled)

54. A filter medium for a liquid, the medium comprising a carbonaceous material, a water-insoluble metal oxide or hydroxide, and at least one of chitosan and an ion exchanger.

55. The filter medium according to claim 54, wherein the carbonaceous material is selected from the group consisting of charcoal, activated charcoal, activated carbon, bituminous coal, impregnated activated carbon, bone char, acid washed activated carbon, coconut shell based activated carbon, wood based activated carbon, regenerated activated carbon, anthracite coal, zeolite mixed coal, virgin activated carbon, water-washed catalytic carbon, charred vegetation, and fly ash.

56. The filter medium according to claim 55, wherein the carbonaceous material is in a particulate form selected from the group consisting of palletized, granular, fibrous, and crushed.

57. The filter medium according to claim 54, wherein the carbonaceous material is impregnated with at least one organic or inorganic compound.

58. The filter medium according to claim 57, wherein the at least one inorganic metal ion is silver or copper.

59. The filter medium according to claim 54, wherein the metal oxide or hydroxide is selected from oxide, hydroxides and/or oxide-hydroxide of iron, alumina and silica.

60. The filter medium according to claim 59, wherein the metal oxide is selected from the group consisting of iron oxide particulates, aluminum oxide particulates, iron nanoparticles on aluminum oxide, iron nanoparticles on diatomaceous earth, iron nanoparticles on microlite ceramic spheres, iron oxide (Fe₂O₃) on silica (SiO₂), iron oxide on alumina (Al₂O₃), ceramic spheres coated with alumina, iron oxide on alumina, aluminum hydroxide (Al(OH)₃) on iron hydroxide (Fe(OH)₃), and iron hydroxide on aluminum hydroxide.

61. The filter medium according to claim 54, wherein the metal hydroxide is selected from hydrated iron-hydroxide prepared from FeCl₃, hydrated iron-oxide embedded onto porous polystyrene beads or hydrated iron hydroxide embedded in ceramic or polymeric supports

62. The filter medium according to claim 54, wherein the medium comprises a combination of a metal oxide and a metal hydroxide.

63. The filter medium according to claim 54, comprising chitosan and at least one ion exchanger.

64. The filter medium according to claim 54, comprising chitosan or at least one ion exchanger.

65. The filter medium according to claim 63, wherein the at least one ion exchanger is an anion exchange resin, a cation exchange resin or any combination thereof.

66. The filter medium according to claim 54, wherein the chitosan is water insoluble-chitosan selected from the group consisting of chitosan (deacetylated chitin), salts of chitosan, chitosan-gel, and modified chitosan.

67. The filter medium according to claim 54, further comprising at least one water-insoluble additive selected from the group consisting of a cation exchange agent, an anion exchange agent, an antimicrobial agent, and at least one other component for removal of specific contaminants.

68. A filter medium consisting of water-insoluble carbonaceous material, water-insoluble metal oxide, and at least one of water-insoluble chitosan and ion exchanger.

69. The filter medium according to claim 54, wherein the medium does not comprise chitosan.

70. A filtering unit comprising a filter medium according to claim 54; and a liquid channeling structure for directing a liquid entering an input of the filtering unit to flow through the filtering medium before exiting an output of the filtering unit.

71. The filtering unit according to claim 70, further comprising a separate compartment for the metal oxide/hydroxide component.

72. The filtering unit according to claim 70, further comprising a separate compartment for at least one antimicrobial agent.

73. A kit comprising a filter medium according to claim 54, and instructions for use.

74. The filter medium according to claim 64, wherein the at least one ion exchanger is an anion exchange resin, a cation exchange resin or any combination thereof.
